(19) United States
(12) Patent Application Publication
(10) Pub. No.: US 2005/0012231 A1
(43) Pub. Date: Jan. 20, 2005

(54) Method of producing a ceramic body by coalescence and the ceramic body produced

(76) Inventors: Kent Olsson, Stockholm (SE); Jianguo Li, Huddinge (SE)

Correspondence Address: Karin Larsson;Albihns Stockholm, Box 5581, Stockholm, 11485, SE

(21) Appl. No.: 10/343,084

(22) PCT Filed: Jul. 25, 2001
(86) PCT No.: PCT/SE01/01673

(30) Foreign Application Priority Data
Jul. 25, 2000 (SE) 0002770-6

(51) Int. Cl. A61C 13/08; B28B 3/00

(52) U.S. Cl. 264/19; 264/667; 264/109

(57) ABSTRACT

A method of producing a ceramic body by coalescence, wherein the method comprises the steps of a) filling a pre-compacting mould with ceramic material in the form of powder, pellets, grains and the like, b) pre-compacting the material at least once and c) compressing the material in a compression mould by at least one stroke, where a striking unit emits enough kinetic energy to form the body when striking the material inserted in the compression mould, causing coalescence of the material. A method of producing a ceramic body by coalescence, wherein the method comprises compressing material in the form of a solid ceramic body in a compression mould by at least one stroke, where a striking unit emits enough energy to cause coalescence of the material in the body. Products obtained by the inventive methods.

The invention concerns a method of producing a ceramic body by coalescence as well as the ceramic body produced by this method.

### STATE OF THE ART

In WO-A1-9700751, an impact machine and a method of cutting rods with the machine is described. The document also describes a method of deforming a metal body. The method utilises the machine described in the document and is characterised in that a metallic material either in solid form or in the form of powder such as grains, pellets and the like, is fixed preferably at the end of a mould, holder or the like and that the material is subjected to adiabatic coalescence by a striking unit such as an impact ram, the motion of the ram being effected by a liquid. The machine is thoroughly described in the WO document.

In WO-A1-9700751, shaping of components, such as spheres, is described. A metal powder is supplied to a tool divided in two parts, and the powder is supplied through a connecting tube. The metal powder has preferably been gas-atomized. A rod passing through the connecting tube is subjected to impact from the percussion machine in order to influence the material enclosed in the spherical mould.

However, it is not shown in any embodiment specifying parameters for how a body is produced according to this method.

The compacting according to this document is performed in several steps, e.g. three.

These steps are performed very quickly and the three strokes are performed as described below.

Stroke 1: an extremely light stroke, which forces out most of the air from the powder and orients the powder particles to ensure that there are no great irregularities.

Stroke 2: a stroke with very high energy density and high impact velocity, for local adiabatic coalescence of the powder particles so that they are compressed against each other to extremely high density. The local temperature increase of each particle is dependent on the degree of deformation during the stroke.

Stroke 3: a stroke with medium-high energy and with high contact energy for final shaping of the substantially compact material body. The compacted body can thereafter be sintered.

In SE 9803956-3 a method and a device for deformation of a material body are described. This is substantially a development of the invention described in WO-A1-9700751. In the method according to the Swedish application, the striking unit is brought to the material by such a velocity that at least one rebounding blow of the striking unit is generated, wherein the rebounding blow is counteracted whereby at least one further stroke of the striking unit is generated.

The strokes according to the method in the WO document, give a locally very high temperature increase in the material, which can lead to phase changes in the material during the heating or cooling. When using the counteracting of the rebounding blows and when at least one further stroke is generated, this stroke contributes to the wave going back and forth and being generated by the kinetic energy of the first stroke, proceeding during a longer period. This leads to further deformation of the material and with a lower impulse than would have been necessary without the counteracting. It has now shown that the machine according to these mentioned documents does not work so well. For example are the time intervals between the strokes, which they mention, not possible to obtain. Further, the document does not comprise any embodiments showing that a body can be formed.

### OBJECT OF THE INVENTION

The object of the present invention is to achieve a process for efficient production of products from ceramic at a low cost. These products may be both medical devices such as medical implants or bone cement in orthopaedic surgery, instruments or diagnostic equipment, or non medical devices such as tools, insulator applications, crucibles, spray nozzles, tubes, cutting edges, jointing rings, ball bearings and engine parts. Another object is to achieve a ceramic product of the described type.

It should also be possible to perform the new process at a much lower velocity than the processes described in the above documents. Further, the process should not be limited to using the above described machine.

### SHORT DESCRIPTION OF THE INVENTION

It has surprisingly been found that it is possible to compress different ceramics according to the new method defined in claim 1. The material is for example in the form of powder, pellets, grains and the like and is filled in a mould, pre-compacted and compressed by at least one stroke. The machine to use in the method may be the one described in WO-A1-9700751 and SE 9803956-3.

The method according to the invention utilises hydraulics in the percussion machine, which may be the machine utilised in WO-A1-9700751 and SE 9803956-3. When using pure hydraulic means in the machine, the striking unit can be given such movement that, upon impact with the material to be compressed, it emits sufficient energy at sufficient speed for coalescence to be achieved. This coalescence may be adiabatic. A stroke is carried out quickly and for some materials the wave in the material decay in between 5 and 15 milliseconds. The hydraulic use also gives a better sequence control and lower running costs compared to the use of compressed air. A spring-actuated percussion machine will be more complicated to use and will give rise to long setting times and poor flexibility when integrating it with other machines. The method according to the invention will thus be less expensive and easier to carry out. The optimal machine has a large press for pre-compacting and post-compacting and a small striking unit with high speed. Machines according to such a construction are therefore probably more interesting to use. Different machines could also be used, one for the pre-compacting and post-compacting and one for the compression.

### SHORT DESCRIPTION OF THE DRAWINGS

On the enclosed drawings

FIG. 1 shows a cross sectional view of a device for deformation of a material in the form of a powder, pellets, grains and the like, and

FIGS. 2-44 are diagrams showing results obtained in the embodiments described in the examples.

### DETAILED DESCRIPTION OF THE INVENTION

The invention concerns a method of producing a ceramic body by coalescence, wherein the method comprises the steps of
a) filling a pre-compacting mould with ceramic material in the form of powder, pellets, grains and the like,
b) pre-compacting the material at least once and
c) compressing the material in a compression mould by at least one stroke, where a striking unit emits enough kinetic energy to form the body when striking the material inserted in the compression mould, causing coalescence of the material.

The pre-compacting mould may be the same as the compression mould, which means that the material does not have to be moved between the step b) and c). It is also possible to use different moulds and move the material between the steps b) and c) from the pre-compacting mould to the compression mould. This could only be done if a body is formed of the material in the pre-compacting step.

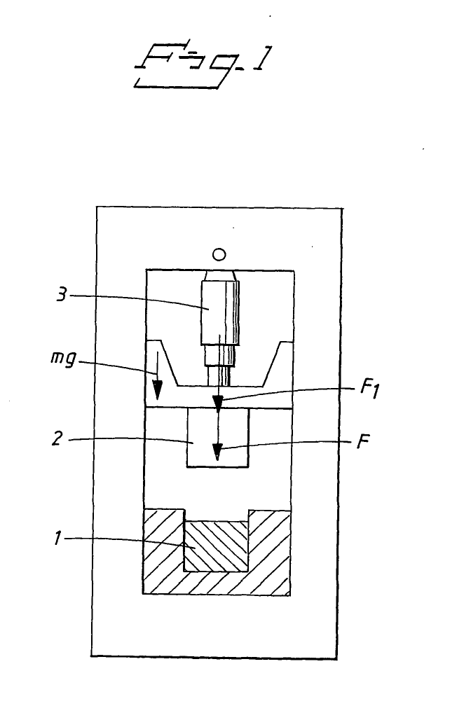

The device in FIG. 1 comprises a striking unit 2. The material in FIG. 1 is in the form of powder, pellets, grains or the like. The device is arranged with a striking unit 3, which with a powerful impact may achieve an immediate and relatively large deformation of the material body 1. The invention also refers to compression of a body, which will be described below. In such a case, a solid body 1, such as a solid homogeneous ceramic body, would be placed in a mould.

The striking unit 2 is so arranged, that, under influence of the gravitation force, which acts thereon, it accelerates against the material 1. The mass m of the striking unit 2 is preferably essentially larger than the mass of the material 1. By that, the need of a high impact velocity of the striking unit 2 can be reduced somewhat. The striking unit 2 is allowed to hit the material 1, and the striking unit 2 emits enough kinetic energy to compact and form the body when striking the material in the compression mould. This causes a local coalescence and thereby a consequent deformation of the material 1 is achieved. The deformation of the material 1 is plastic and consequently permanent. Waves or vibrations are generated in the material 1 in the direction of the impact direction of the striking unit 2. These waves or vibrations have high kinetic energy and will activate slip planes in the material and also cause relative displacement of the grains of the powder. It is possible that the coalescence may be an adiabatic coalescence. The local increase in temperature develops spot welding (inter-particular melting) in the material which increases the density.

The pre-compaction is a very important step. This is done in order to drive out air and orient the particles in the material. The pre-compaction step is much slower than the compression step, and therefore it is easier to drive out the air. The compression step, which is done very quickly, may not have the same possibility to drive out air. In such case, the air may be enclosed in the produced body, which is a disadvantage. The pre-compaction is performed at a minimum pressure enough to obtain a maximum degree of packing of the particles which results in a maximum contact surface between the particles. This is material dependent and depends on the softness and melting point of the material.

The pre-compacting step in the Examples has been performed by compacting with an axial load of about 117680 N. This is done in the pre-compacting mould or the final mould. According to the examples in this description, this has been done in a cylindrical mould, which is a part of the tool, and has a circular cross section with a diameter of 30 mm, and the area of this cross section is about 7 cm². This means that a pressure of about 1.7×10⁸ N/m² has been used. For hydroxyapatite the material may be pre-compacted with a pressure of at least about 0.25×10⁸ N/m², and preferably with a pressure of at least about 0.6×10⁸ N/m². The necessary or preferred pre-compaction pressure to be used is material dependent and for a softer ceramic it could be enough to compact at a pressure of about 2000 N/r². Other possible values are 1.0×10⁸ N/r², 1.5×10⁸ N/m². The studies made in this application are made in air and at room temperature. All values obtained in the studies are thus achieved in air and room temperature. It may be possible to use lower pressures if vacuum or heated material is used. The height of the cylinder is 60 mm. In the claims is referred to a striking area and this area is the area of the circular cross section of the striking unit which acts on the material in the mould.

The striking area in this case is the cross section area.

In the claims it is also referred to the cylindrical mould used in the Examples. In this mould the area of the striking area and the area of the cross section of the cylindrical mould are the same. However, other constructions of the moulds could be used, such as a spherical mould. In such a mould, the striking area would be less than the cross section of the spherical mould.

The invention further comprises a method of producing a ceramic body by coalescence, wherein the method comprises compressing material in the form of a solid ceramic body (i.e. a body where the target density for specific applications has been achieved) in a compression mould by at least one stroke, where a striking unit emits enough energy to cause coalescence of the material in the body. Slip planes are activated during a large local temperature increase in the material, whereby the deformation is achieved. The method also comprises deforming the body.

The method according to the invention could be described in the following way.

1) Powder is pressed to a green body, the body is compressed by impact to a (semi)solid body and thereafter an energy retention may be achieved in the body by a post-compacting. The process, which could be described as Dynamic Forging Impact Energy Retention (DFIER) involves three mains steps.
a) Pressuring
   The pressing step is very much like cold and hot pressing. The intention is to get a green body from powder. It has turned out to be most beneficial to perform two compactions of the powder. One compaction alone gives about 2-3% lower density than two consecutive compactions of the powder. This step is the preparation of the powder by evacuation of the air and orientation of the powder particles in a beneficial way. The density values of the green body is more or less the same as for normal cold and hot pressuring.
b) Impact
   The impact step is the actual high-speed step, where a striking unit strikes the powder with a defined area. A material wave starts off in the powder and interparticular melting takes place between the powder particles. Velocity of the string unit seems to have an important role only during a very short time initially. The mass of the powder and the properties of the material decides the extent of the interparticular melting taking place.
c) Energy retention
   The energy retention step aims at keeping the delivered energy inside the solid body produced. It is physically a compaction with at least the same pressure as the pre-compaction of the powder. The result is an increase of the density of the produced body by about 1-2%. It is performed by letting the striking unit stay in place on the solid body after the impact and press with at least the same pressure as at pre-compaction, or release after the impact step. The idea is that more transformations of the powder will take place in the produced body.

According to the method, the compression strokes emit a total energy corresponding to at least 100 Nm in a cylindrical tool having a striking area of 7 cm² in air and at room temperature. Other total energy levels may be at least 300, 600, 1000, 1500, 2000, 2500, 3000 and 3500 Nm. Energy levels of at least 10 000, 20 000 Nm may also be used. There is a new machine, which has the capacity to strike with 60 000 Nm in one stroke. Of course such high values may also be used. And if several such strikes are used, the total amount of energy may reach several 100 000 Nm. The energy levels depend on the material used, and in which application the body produced will be used. Different energy levels for one material will give different relative densities of the material body. The higher energy level, the more dense material will be obtained. Different materials will need different energy levels to get the same density. This depends on for example the hardness of the material and the melting point of the material.

According to the method, the compression strokes emit an energy per mass corresponding to at least 5 Nm/g in a cylindrical tool having a striking area of 7 cm² in air and at room temperature. Other energies per mass may be at least 20 Nm/g, 50 Nm/g, 100 Nm/g, 150 Nm/g, 200 Nm/g, 250 Nm/g, 350 Nm/g and 450 Nm/g.

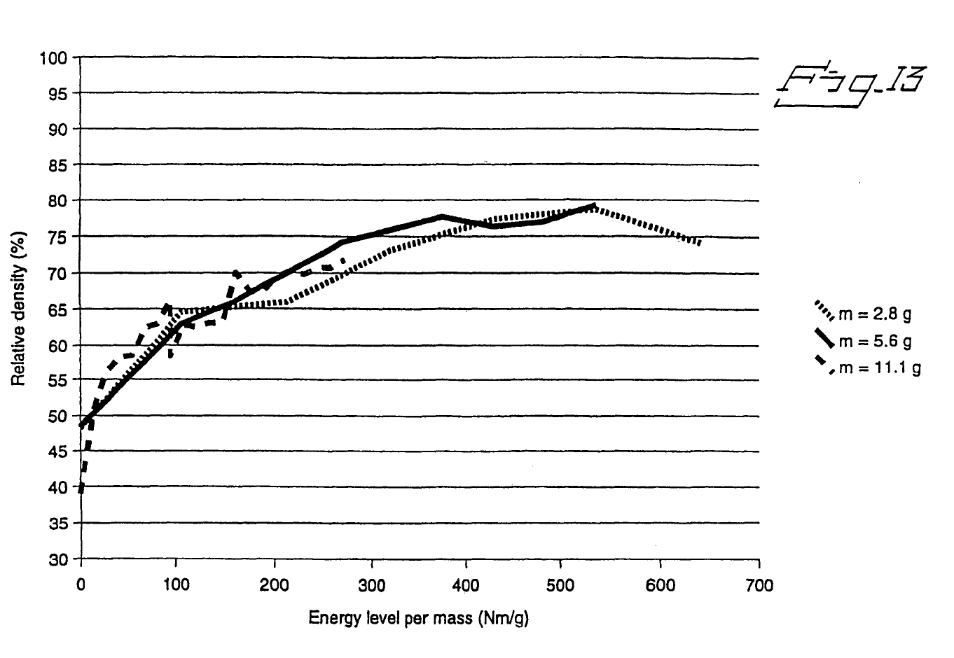

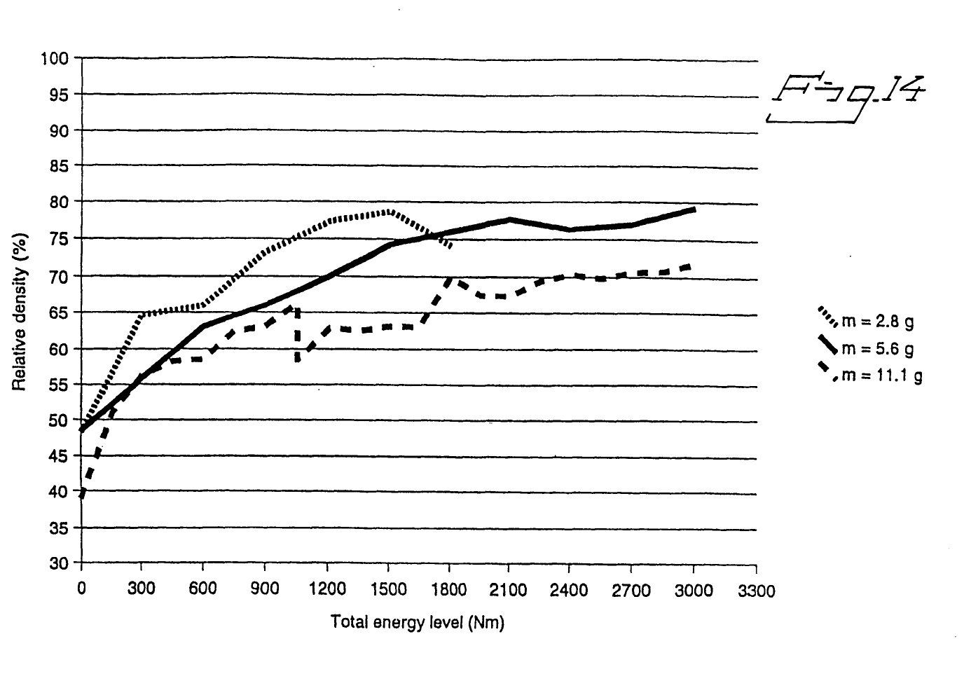

There seems to be a linear relationship between the mass of the sample and the energy needed to achieve a certain relative density. This is shown in a mass parameter study for hydroxyapatite in Example 2, and can be seen in FIG. 13 where the relative density as a function of impact energy per mass is shown. It can also be seen in FIG. 14, where the relative density as a function of the total impact energy is shown.

For the samples tested in the Examples in the mass parameter study, the result is the following. The same total energy per mass for the compression strokes gives about the same density for a produced body. Thus, for the weight interval measured and for hydroxyapatite the total energy is essentially linearly dependent of the mass.

These values will vary dependent on what material is used. A person skilled in the art will be able to test at what values the mass dependency will be valid and when there may be a mass independence.

The energy level needs to be amended and adapted to the form and construction of the mould. If for example, the mould is spherical, another energy level will be needed. A person skilled in the art will be able to test what energy level is needed with a special form, with the help and direction of the values given above. The energy level depends on what the body will be used for, i.e. which relative density is desired, the geometry of the mould and the properties of the material. The striking unit must emit enough kinetic energy to form a body when striking the material inserted in the compression mould. With a higher velocity of the stroke, more vibrations, increased friction between particles, increased local heat, and increased interparticular melting of the material will be achieved. The bigger the stroke area is, the more vibrations are achieved. There is a limit where more energy win be delivered to the tool than to the material. Therefore, there is also an optimum for the height of the material.

When a powder of a ceramic material is inserted in a mould and the material is struck by a striking unit, a coalescence is achieved in the powder material and the material will float. A probable explanation is that the coalescence in the material arises from waves being generated back and forth at the moment when the striking unit rebounds from the material body or the material in the mould. These waves give rise to a kinetic energy in the material body. Due to the transmitted energy a local increase in temperature occurs, and enables the particles to soften, deform and the surface of the particles will melt. The inter-particular melting enables the particles to re-solidify together and dense material can be obtained. This also affects the smoothness of the body surface. The more a material is compressed by the coalescence technique, the smoother surface is obtained. The porosity of the material and the surface is also affected by the method. If a porous surface or body is desired, the material should not be compressed as much as if a less porous surface or body is desired.

The individual strokes affect material orientation, driving out air, pre-moulding, coalescence, tool filling and final calibration. It has been noted that the back and forth going waves travels essentially in the stroke direction of the striking unit, i.e. from the surface of the material body which is hit by the striking unit to the surface which is placed against the bottom of the mould and then back.

What has been described above about the energy transformation and wave generation also refer to a solid body. In the present invention a solid body is a body where the target density for specific applications has been achieved.

The striing unit preferably has a velocity of at least 0.1 m/s or at least 1.5 m/s during the stroke in order to give the impact the required energy level. Much lower velocities may be used than according to the technique in the prior art. The velocity depends on the weight of the striking unit and what energy is desired. The total energy level in the compression step is at least about 100 to 4000 Nm. But much higher energy levels may be used. By total energy is meant the energy level for all strokes added together. The striking unit makes at least one stroke or a number of consecutive strokes. The interval between the strokes according to the Examples was 0.4 and 0.8 seconds. For example at least two strikes may be used. According to the Examples one stroke has shown promising results. These Examples were performed in air and at room temperature. If for example vacuum and heat or some other improving treating is used, perhaps even lower energies may be used to obtain good relative densities.

The ceramic may be compressed to a relative density of 45%, preferably 50%. More preferred relative densities are also 55% and 60%. Other preferred densities are 70 and 80%. Densities of at least 90 and up to 100% are especially preferred. However, other relative densities are also possible. If a green body is to be produced, it could be enough with a relative density of about 40-60%. Low bearing implant desires a relative density of 90 to 100% and in some biomaterials it is good with some porosity. If a porosity of 5% or less is obtained and this is sufficient for the use, no flrher post-processing is necessary. This may be the choice for certain applications. If a relative density of less than 95% is obtained, and this is not enough, the process need to continue with further processing such as sintering. Several manufacturing steps have even in this case been cut compared to conventional manufacturing methods.

The method also comprises pre-compacting the material at least twice. It has been shown that this could be advantageous in order to get a high relative density compared to strokes used with the same total energy and only one pre-compacting. Two compactions may give about 1-5% higher density than one compacting depending on the material used. The increase may be even higher for some materials. When pre-compacting twice, the compacting steps are performed with a small interval between, such as about 5 seconds. About the same pressure may be used in the second pre-compacting.

Further, the method may also comprise a step of compacting the material at least once after the compression step. This has also been shown to give very good results. The post-compacting should be carried out at at least the same pressure as the pre-compacting pressure, i.e. 0,25×10⁸ N/m². Other possible values are 1.0×10⁸ N/m². Higher post-compacting pressures may also be desired, such as a pressure which is twice the pressure of the pre-compacting pressure. For hydroxyapatite the pre-compacting pressure should be at least about 0.25×10⁸ N/m² and this would be the lowest possible post-compacting pressure for hydroxyapatite. The pre-compacting value has to be tested out for every material. A post-compacting effects the sample differently than a pre-compacting. The transmitted energy, which increases the local temperature between the powder particles from the stroke, is conserved for a longer time and can effect the sample to consolidate for a longer period after the stroke. The energy is kept inside the solid body produced. Probably the “lifetime” for the material wave in the sample increases and it can affect the sample for a longer period and more particles can melt together. The after compaction or post-compaction is performed by letting the striking unit stay in place on the solid body after the impact and press with at least the same pressure as at pre-compacting, i.e. at least about 0.25×10⁸ N/m² for hydroxyapatite. More transformations of the powder will take place in the produced body. The result is an increase of the density of the produced body by about 1-4%. Also this possible increase is material dependent.

When using pre-compacting and/or after compacting, it could be possible to use lighter strokes and higher pre- and/or after compacting, which would lead to saving of the tools, since lower energy levels could be used. This depends on the intended use and what material is used. It could also be a way to get a higher relative density.

To get improved relative density it is also possible to pre-process the material before the process. The powder could be pre-heated to e.g. ˜200-300° C. or higher depending on what material type to pre-heat. The powder could be pre-heated to a temperature which is close to the melting temperature of the material. Suitable ways of pre-heating may be used, such as normal heating of the powder in an oven. In order to get a more dense material during the pre-compacting step vacuum or inert gas could be used. This would have the effect that air is not enclosed in the material to the same extent during the process.

The body may according to another embodiment of the invention be heated and/or sintered any time after compression or post-compacting. A post-heating is used to relax the bindings in the material (obtained by increased binding strain). A lower sintering temperature may be used owing to the fact that the compacted body has a higher density than compacts obtained by other types of powder compression. This is an advantage as a higher temperature may cause decomposition or transformation of the constituting material. The produced body may also be post-processed in some other way, such as by HIP (Hot Isostatic Pressing).

Further, the body produced may be a green body and the method may also comprise a further step of sintering the green body. The green body of the invention gives a coherent integral body even without use of any additives. Thus, the green body may be stored and handled and also worked, for instance polished or cut. It may also be possible to use the green body as a finished product, without any intervening sintering. This is the case when the body is a bone implant or replacement where the implant is to be resorbed in the bone.

Before processing the ceramic could be homogenously mixed with additives. Predrying of the granulate could also be used to decrease the water content of the raw material. Some ceramics do not absorb humidity, while other ceramics easily absorb humidity which can disturb the processing of the material, and decrease the homogeneity of the worked material because a high humidity rate can raise steam bubbles in the material.

The ceramic may be chosen from the group comprising minerals, oxides, carbides, nitrides. As examples alumina, silica, silicon nitride, zirconia, silicon carbide and hydroxyapatite may be mentioned.

The compression strokes need to emit a total energy corresponding to at least 100 Nm in a cylindrical tool having a striking area of 7 cm² for oxides. The same value for nitrides, carbides and other ceramics is also 100 Nm. The compression strokes need to emit an energy per mass corresponding to at least 5 Nm/g in a cylindrical tool having a striking area of 7 cm² for ceramics.

It has been shown earlier that better results have been obtained with particles having irregular particle morphology. The particle size distribution should probably be wide. Small particles could fill up the empty space between big particles.

The ceramic material may comprise a lubricant and/or a sintering aid. A lubricant may be useful to mix with the material. Sometimes the material needs a lubricant in the mould, in order to easily remove the body. In certain cases this could be a choice if a lubricant is used in the material, since this also makes it easier to remove the body from the mould.

A lubricant cools, takes up space and lubricates the material particles. This is both negative and positive.

Interior lubrication is good, because the particles will then slip in place more easily and thereby compact the body to a higher degree. It is good for pure compaction. Interior lubrication decreases the friction between the particles, thereby emitting less energy, and the result is less inter-particular melting. It is not good for compression to achieve a high density, and the lubricant must be removed for example with sintering.

Exterior lubrication increases the amount of energy delivered to the material and thereby indirectly diminishes the load on the tool. The result is more vibrations in the material, increased energy and a greater degree of inter-particular melting. Less material sticks to the mould and the body is easier to extrude. It is good for both compaction and compression.

An example of a lubricant is Acrawax C, but other conventional lubricants may be used. If the material will be used in a medical body, the lubricant need to be medically acceptable, or it should be removed in some way during the process.

Polishing and cleaning of the tool may be avoided if the tool is lubricated and if the powder is preheated.

A sintering aid may also be included in the material. The sintering aid may be useful in a later processing step, such as a sintering step. However, the sintering aid is in some cases not so useful during the method embodiment, which does not include a sintering step. The sintering aid may be yttrium oxide, alumina or magnesia or some other conventional sintering aid. It should, as the lubricant, also be medically acceptable or removed, if used in a medical body.

In some cases, it may be useful to use both a lubricant and a sintering aid. This depends on the process used, the material used and the intended use of the body which is produced.

In some cases it may be necessary to use a lubricant in the mould in order to remove the body easily. It is also possible to use a coating in the mould. The coating may be made of for example TiNAl or Balinit Hardlube. If the tool has an optimal coating no material will stick to the tool parts and consume part of the delivered energy, which increase the energy delivered to the powder. No time-consuming lubricating would be necessary in cases where it is difficult to remove the formed body.

In Example 3 several external lubricants are tested. It is shown that Teflon grease and molybdenum sulfide showed better results than for example oils.

A very dense material, and depending on the material, a hard material will be achieved, when the ceramic material is produced by coalescence. The surface of the material will be very smooth, which is important in several applications.

If several strokes are used, they may be executed continually or various intervals may be inserted between the strokes, thereby offering wide variation with regard to the strokes.

For example, one to about six strokes may be used. The energy level could be the same for all strokes, the energy could be increasing or decreasing. Stroke series may start with at least two strokes with the same level and the last stroke has the double energy. The opposite could also be used. A study of different type of strokes in consecutive order is performed in one Example.

The highest density is obtained by delivering a total energy with one stroke. If the total energy instead is delivered by several strokes a lower relative density is obtained, but the tool is saved. A multi-stroke can therefore be used for applications where a maximum relative density is not necessary.

Through a series of quick impacts a material body is supplied continually with kinetic energy which contributes to keep the back and forth going wave alive. This supports generation of further deformation of the material at the same time as a new impact generates a further plastic, permanent deformation of the material.

According to another embodiment of the invention, the impulse, with which the striking unit hits the material body, decreases for each stroke in a series of strokes. Preferably the difference is large between the first and second stroke. It will also be easier to achieve a second stroke with smaller impulse than the first impulse during such a short period (preferably approximately 1 ms), for example by an effective reduction of the rebounding blow. It is however possible to apply a larger impulse than the first or preceding stroke, if required.

According to the invention, many variants of impacting are possible to use. It is not necessary to use the counteracting of the striking unit in order to use a smaller impulse in the following strokes. Other variations may be used, for example where the impulse is increasing in following strokes, or only one stroke with a high or low impact. Several different series of impacts may be used, with different time intervals between the impacts.

A ceramic body produced by the method of the invention, may be used in medical devices such as medical implants or bone cement in orthopaedic surgery, instruments or diagnostic equipment. Such implants may be for examples skeletal or tooth prostheses.

According to an embodiment of the invention, the material is medically acceptable. Such materials are for example suitable ceramics, such as hydroxyapatite and zirconia.

A material to be used in implants needs to be biocompatible and haemocompatible as well as mechanically durable, such as hydroxyapatite and zirconia or other suitable ceramics.

The body produced by the process of the present invention may also be a non medical product such as tools, insulator applications, crucibles, spray nozzles, tubes, cutting edges, jointing rings, ball bearings and engine parts.

Here follows several applications for some of the materials. Applications for silicon nitride are crucibles, spray nozzles, tubes, cutting edges, jointing rings, ball bearings and engine parts. Alumina is a good electrical insulator and has at the same time an acceptable thermal conductivity and is therefore used for producing substrates where electrical components are mounted, insulation for ignition plugs and insulation in the high-tension areas. Alumina is also a common material type in orthopaedic implants, e.g. femoral-head in hip prostheses. Hydroxyapatite is one of the most important biomaterials extensively used in orthopaedic surgery. Common applications for zirconia are cutting tools, components to adiabatic engines and it is also a common material type in orthopaedic implants, e.g. femoral-head in hip prostheses. The invention thus has a big application area for producing products according to the invention.

When the material inserted in the mould is exposed to the coalescence, a hard, smooth and dense surface is achieved on the body formed. This is an important feature of the body. A hard surface gives the body excellent mechanical properties such as high abrasion resistance and scratch resistance. The smooth and dense surface makes the material resistant to for example corrosion. The less pores, the larger strength is obtained in the product. This refers to both open pores and the total amount of pores. In conventional methods, a goal is to reduce the amount of open pores, since open pores are not possible to get reduced by sintering.

It is important to admix powder mixtures until they are as homogeneous as possible in order to obtain a body having optimum properties.

A coating may also be manufactured according to the method of the invention. One ceramic coating may for example be formed on a surface of a ceramiclic element of another ceramic or some other material. When manufacturing a coated element, the element is placed in the mould and may be fixed therein in a conventional way. The coating material is inserted in the mould around the element to be coated, by for example gas-atomizing, and thereafter the coating is formed by coalescence. The element to be coated may be any material formed according to this application, or it may be any conventionally formed element. Such a coating may be very advantageously, since the coating can give the element specific properties.

A coating may also be applied on a body produced in accordance with the invention in a conventional way, such as by dip coating and spray coating.

It is also possible to first compress a material in a first mould by at least one stroke. Thereafter the material may be moved to another, larger mould and a further ceramic material be inserted in the mould, which material is thereafter compressed on top of or on the sides of the first compressed material, by at least one stroke. Many different combinations are possible, in the choice of the energy of the strokes and in the choice of materials.

The invention also concerns the product obtained by the methods described above.

The method according to the invention has several advantages compared to pressing. Pressing methods comprise a first step of forming a green body from a powder containing sintering aids. This green body will be sintered in a second step, wherein the sintering aids are burned out or may be burned out in a further step. The pressing methods also require a final working of the body produced, since the surface need to be mechanically worked. According to the method of the invention, it is possible to produce the body in one step or two steps and no mechanical working of the surface of the body is needed.

By the use of the present process it is possible to produce large bodies in one piece. In presently used processes it is often necessary to produce the intended body in several pieces to be joined together before use. The pieces may for example be joined using screws or adhesives or a combination thereof.

A further advantage is that the method of the invention may be used on powder carrying a charge repelling the particles without treating the powder to neutralize the charge. The process may be performed independent of the electrical charges or surface tensions of the powder particles. However, this does not exclude a possible use of a further powder or additive carrying an opposite charge. By the use of the present method it is possible to control the surface tension of the body produced. In some instances a low surface tension may be desired, such as for a wearing surface requiring a liquid film, in other instances a high surface tension is desired.

The invention may comprise the following steps of pretreatment, posttreatment and powder preparation:

Pre-Treatment of As-Received Powders

Use of the as-received powder without any pre-treatment. This excludes any addition of pressing aid or sintering aid. This also excludes automatic filling of the pressing tool since the flow properties are so poor.

Ball milling followed by
a. freeze granulation and freeze-drying or
b. spray-drying or
c. brick-drying and sieve granulation
d. rotary-evaporation and sieve drying.
These pre-treatments allow additions of pressing and sintering aids as well as automatic tool filling. To achieve proper suspension properties (low viscosity at high particle concentration) a dispersant or pH-adjustment is needed. It may also be possible to use automatic tool filling without pressing aids.

Pre-forming by
a. slip casting,
b. centrifugal casting,
c. pressure casting or
d. filter pressing.
All methods need a dispersant and they allow addition of sintering aids. It is also possible to add binder to support the green strength. Loading of pre-formed bodies in the machine may be done manually. Otherwise, a special arrangement, that softly place the body in the punch, should be used.

Pre-forming by uniaxial pressing. This is used as one operation sequence in the machine.

Pre-forming by wet or dry CIP (cold isostatic pressing). This can be used as one operation sequence before the coalescing machine.

Pressing Aids and Sintering Aids

There are many options regarding pressing aids. In conventional pressing a mix of two compounds are generally used. One is a polymer that will act as a binder, for example PVA, PEG or Latex. The other compound is a low Mw polymer (PEG) or a fatty acid (glycerol or similar) that will act as plasticizer and promote the pressing operation. PEG is often a better choice as softener since glycerol is more hydroscopic and can alter the pressing properties. The binder is used to give sufficient green strength, however, when the method of the invention is used the binder may often be excluded since it is, at least partly, decomposed and enough rigidity is achieved by the high-energy compression. Binder is sometimes also used in slip casting to make the green body less brittle and enable green machining. However, slip cast bodies most often have enough strength to be handled without binder. Binder addition also affects the slip casting process by lower casting rate. The binder can also segregate towards the mould surface.

Regarding sintering aids, alumina can be conventionally sintered without. However, small amount of MgO (0.05 wt %) is often used and can enable complete densification and also inhibit critical grain growth. Also other oxides, like CaO and Y₂O₃, are used but then in larger amounts. The need of any sintering aid depends on how far the material is densified by the process and the need of post-sintering. The addition may also need to fulfil the requirements for biomaterial applications.

For Si₃N₄, wide variations of sintering aids are used depending on sintering technique and the application. The amount is in the range of 2-10 wt % based on powder. More powerfiil sintering (HP or HIP) and high-temperature applications requires lower amounts. Common sintering aids are Al₂O₃, Y₂O₃, SiO₂, MgO and Yb₂O₃ in various portions and combinations. Note that Si₃N₄ already contains some SiO₂ on the particle surfaces (can be increased by calcination) that will take part in the liquid phase formation during sintering. Here it may also be necessary to consider the requirements for biomaterials.

Another aspect is the state of the sintering aids. It can be as fine powder (most often used) but also as salt or sots. Sots is stable dispersions of extremely small particles (10-100 nm) that sometimes are adsorbed on the particle surfaces and also act as a dispersing agent. Sots are only available for some few oxides such as Al₂O₃, Y₂O₃ or SiO₂. The advantage of using sols is the homogeneous distribution of the sintering aids that potentially can be achieved. This makes it possible to reduce the amount of addition for the sintering performance. The same can be for salts but high ion concentration reduces the stability of powder suspensions that need to be considered.

Machine Arrangements—Pressing Conditions

Pre-heating of powder and tool to support the compaction and reduce the energy input.

Note that the level of temperature needs to be adapted to any present pressing aid so that it does not decompose or lose its performance. This concept is successfully used for metal powder but may also be applied for ceramics. It is believed that metal particles get softer and then deform more easily even though the temperature is far from the melting point. For ceramics the main advantage is the possibility to reduce the energy input. It is not reasonable to believe that any softening will occur.

Apply vacuum to the tool.

This should support and enable complete densification by removing air and decomposed organic additives. However, this may increase the costs. It may also be possible too apply another atmosphere.

Apply grease to the mould surface.

This may reduce the need to add such to the powder, complete or partly. The need of pressing aid added to the powder appears to be more critical for ceramics.

Use of different tool materials.

Especially it is possible to use surface treatment or deposition (CVD, PVD or plasma spraying) of a surface layer to reduce friction and/or wear.

Post Heat Treatment

A heat treatment after the machine operation is often needed for ceramics. A post-sintering will enable sufficient densification. The most common sintering/densification methods are
a. pressureless sintering (PS)
b. gas-pressure sintering (GPS)
c. hot-pressing (HP)
d. glass-encapsulated hot-isostatic pressing (glass-HIP)
e. pressureless sintering and post-HIP (post-HIP)
f. pulse electric current sintering (PECS)

Conventional pressureless sintering schedules for the specific ceramic will often be adequate. However, this will depend on the degree of compaction reached in the machine

Here follow some Examples to illustrate the invention.

### EXAMPLES

Four ceramic types were chosen for investigation The ceramics are chosen to represent all types of ceramic materials: non-oxidized, oxidized and waterbased ceramics. They also includes solid phase (alumina, zirconia) and liquid phase (silicone nitride) sintered ceramics.

All ceramic types are common within the implant industry, but are also commonly used in other application areas e.g tools, engines, insulator applications. Silicone nitride and alumina were tested in four different batches. “Batch 1” is freeze-dried granulated pure powder (silicone nitride) or non-granulated powder (alumina), “batch 2” is freeze-dried granualted powder with processing additives, “batch 3” is freeze-dried granulated powder with sintering aid and “batch 4” is freeze-dried granulated powder with both processing additives and sintering aid. The two other ceramics were only tested in pure form without any pre-processing.

The main objective of the study in Example 1 was to to obtain a relative density of >95%. In that case desired material properties could possibly be obtained without fiber post-processing. If a relative density of <95% is obtained after this manufacturing process it is possible to continue with a post-processing to obtain 100% and desired material properties. Several manufacturing steps would be cut compared to conventional manufacturing methods.

In Example 2 parameter studies were performed. Different parameters were varied to investigate how they could be used to obtain the best result depending on the desired properties of a product. A weight study (A), a velocity study (B), an energy study (C), a number of strokes study (D), a time interval study (E) and a heat study (F) were performed, but only for two chosen material types, hydroxyapatite (A, B, D, E) and silicone nitride (C, F) to represent the parameters' influence on the results for the group ceramics. The object of these investigations were to determine how the different parameters effect the result and to get a knowledge on how the parameters influence material properties.

In Examples 1 and 2 the mould is in all cases treated with a lubricant Acrawax C. In Example 3 the influence on the compressed samples of other lubricants is tested.

Hydroxyapatite was used for testing different lubricants.

Preparation of the Powder

The preparation was the same for all the ceramics, if nothing else is said.

The ceramic powder has to be ground to form a dispersion or a suspension before mixing. The main advantage of using a suspension is that the attraction forces between the powder particles are less, which means that it is easier to separate the powder particles and disintegrate agglomerates in a suspension. The suspension is sieved before different granulation processes. The particle separation can be controlled further by adding dispersion additives to the suspension. A dispersion additive is surface active elements which absorbs on the particles and raise repulsion forces between the particles. There are approximately 0.2-0.3 weight % dispersion additives in a suspension which are driven out during sintering in conventional powder pressing.

Fine ceramic powder has to be granulated to be pressed successfully. The attractive van der Waals forces between fine powders make homogeneous filling of a pressing die impossible without granulation. Freeze-drying is one way of granulation, which can be used for granulation of ceramic and metallic powder. This technology ensures high-quality granules with homogeneous distribution of particles, polymeric pressing aids and other additives.

The powder is prepared for the granulation by grinding the powder in a suspension containing bonding agents and dispersion agents. Lack of bonding agents decrease the strength of the granules. The container with the suspension is collected to a pump and another container containing floating nitrogen. Both container contains magnetic mixers. The suspension is pumped by pressure air from the suspension container and sprayed into the container with floating nitrogen. The nitrogen is consumed while the liquid is frozen. The freezing is fast and the gas bubbles forming around the droplets make it repel from both the walls and and other droplets. No liquid migration takes place during freeze granulation. The droplets are rapidly frozen and the frozen liquid is transported away as a vapor during freeze drying.

The fast refrigeration retains the homogenous structure of the powder particles from the suspension to granules. The initial size of the droplet formed in the spraying nozzle is retained throughout the process. The solid content of the suspension totally controls the density of the granule. The granule density can be controlled by changing the solids concentration of the suspension, which will not affect the spherical granule structure.

The granules are crushed during compacting. The microstructure obtained from conventional powder pressing shows that large intergranular pores are eliminated.

The additives in the suspension is homogenously distributed which enhance the sintering performance. The homogeneity of the particle orientation in the granules and the good floating properties of granules can probably contribute to a easier coalescence of ceramic powders.

Freeze drying is also a good alternative for testing different powder because it can granule small quantities of powder.

After the granulation the granules are stored in a freezer before the freeze drying process. The freeze drier dries the powder and the granules are ready to be processed. It is possible to freeze dry different powder types at the same time. This process is time-consuming and depends on the volume of the frozen liquid and the initial temperature of the powder. The time for one batch can be estimated to 24 hours.

### DESCRIPTION

The first sample in all four batches included in the energy and additives studies was only pre-compacted once with an axial load of 117680 N. The following samples were first pre-compacted, and thereafter compacted with one impact stroke. The impact energy in this series was between 150 and 4050 Nm (some batches stopped at a lower impact energy), and each impact energy step interval was 150 Nm or 300 Nm depending on the batch number.

In A (the weight study), the impact energy interval was from 300 to 3000 Nm with a 300 Nm impact step interval. The only parameter that was varied was the weight of the sample. It rendered different impact energies per mass.

In B (the velocity study), the impact energy interval was from 300 to 3000 Nm with a 300 Nm impact step interval. But here different stroke units (weight difference) were used to obtain different maximum impact velocities.

In C (the energy study), the powder were struck 1 to 6 times with 2400 Nm for each stroke and the time interval between the strokes was constant, 0.4 s.

In D and E (the time interval study and the number of strokes study), the total impact energy level was either 1200 Nm or 2400 Nm. Sequences of two to six stroke using a static axial load of 117680 N. The time interval between the strokes in a sequence was 0.4 or 0.8 s. were investigated. Prior to the impact stroke sequence the specimens were pre-compacted.

In F (the heat study), the samples was pre-heated to 210° C. and then struck once with impact energy interval from 300 to 3000 Nm with a 300 Nm impact step interval.

After each sample had been manufactured, all tool parts were dismounted and the sample was released. The diameter and the thickness were measured with electronic micrometers, which rendered the volume of the body. Thereafter, the weight was established with a digital scale. All input values from micrometers and scale were recorded automatically and stored in separate documents for each batch. Out of these results, the density 1 was obtained by taking the weight divided by the volume.

To be able to continue with the next sample, the tool needed to be cleaned, either only with acetone or also by polishing the tool surfaces with an emery cloth to get rid of the material rests on the tool.

To easier establish the state of a manufactured sample three visibility indexes are used. Visibility index 1 corresponds to a powder sample, visibility index 2 corresponds to a brittle sample and visibility index 3 corresponds to a solid sample.

The theoretical density is either taken from the manufacturer or calculated by taking all included materials weighed depending on the percentage of the specific material. The relative density is obtained by taking the obtained density for each sample divided by the theoretical density.

Density 2, measured with the buoyancy method, was performed with silicone nitride and hydroxyapatite samples. Each sample was measured three times and with that three densities were obtained. Out of these densities the median density was taken and used in the figures. To begin with, all samples were dried out in an oven, in 110° C. for 3 hours, to enable the included water to evaporate. After the samples had cooled down, the dry weight of the samples was determined (m₀). That followed by a water penetration process where the samples were kept in vacuum and water, where two drops wetting agent was added into the water. The vacuum forced out the eventual air and the pores were filled with water instead. After an hour the weight of the samples, both in water (m₂) and in air (m₁), was measured. With m₀, m₁, m₂ and the temperature of the water, the density 2 was determined.

Density 2 for alumina and zirconia was measured with a shorter buoyancy method. Each sample was measured one time. First in air (m₁) and then in water (m₂). Density 2 was obtained by dividing m₁ with (m₁-m₂).

Sample Dimensions

The dimensions of the manufactured sample in these tests are a disc with a diameter of ˜30.0 mm and a height between 5-10 mm. The height depends on the obtained relative density. If a relative density of 100% would be obtained the thickness would be 5.00 mm for all ceramic types.

In the moulding die (part of the tool) a hole with a diameter of 30.00 mm is drilled. The height is 60 mm. Two stamps are used (also parts of the tool). The lower stamp is placed in the lower part of the moulding die. Powder is filled in the cavity that is created between the moulding die and the lower stamp. Thereafter, the impact stamp is placed in the upper part of the moulding die and the tool is ready to perform strokes.

### Example 1

Table 1 shows the properties for the ceramic types used.

TABLE 1

| Properties | Silicone nitride | Hydroxyapatite | Alumina | Zirconia |
|---|---|---|---|---|
| 1. Particle size | <0.5 | <1 | <0.5 | 0.4 |
| (micron) | | | | |
| 2. Particle | <0.5 | <1 | 0.3-0.5 | <0.6 |
| distribution | | | | |
| (micron) | | | | |
| 3. Particle | Irregular | irregular | irregular | irregular |
| morphology | | | | |
| 4. Powder | Freeze-dry | Wet chemistry | Grinding | Spray-dry |
| production | granulation | precipitation | Freeze-dry | granulation |
| | | | granulation | |
| 5. Crystal structure | 98% alfa | Apatite | alfa | tetragonal |
| | 2% beta | | | |
| | (hexagonal) | | | |
| 6. Theoretical | 3.18 (batch 1, 2) | 3.15 g/cm³ | 3.98 (batch 1) | 6.07 |
| density (g/cm³) | 3.27 (batch 3) | | 3.79 (batch 2) | |
| | 3.12 (batch 4) | | 3.98 (batch 3) | |
| | | | 3.79 (batch 4) | |
| 7. Apparent | 0.38 | 0.6 | 0.5-0.8 | — |
| density (g/cm³) | | | | |
| 8. Melt | 1800 | 1600 | 2050 | 2500-2600 |
| temperature | | | | |
| (° C.) | | | | |
| 9. Sintering | 1820 | 900 | 1600-1650 | 1500 |
| temperature | | | | |
| (° C.) | | | | |
| 10. Hardness (HV) | 1570 | 450 | 1770 | 1250-1350 |

An exterior lubrication with Acrawax C was used for all batches. Further, for silicone nitride and alumina 1.5 vol % PEG 400 (plasticiser), 5 vol % PVA (binder) and 0.25 wt % PAA (dispersing agent) were used as lubricants/additives. For zirconia 3 mol % Y₂O₃ (stabiliser) was used. The sintering aids used were 6 wt % Y₂O₃ (silicone nitride), 2 wt % Al₂O₃ (silicone nitride) and 0.05 MgO (alumina).

Table 2 shows the test results of the obtained samples, the relative density and the melt temperature of the materials tested.

TABLE 2

| | Melt | Relative density | Relative density | Relative density | Relative density |
|---|---|---|---|---|---|
| | temperature | (%), batch 1, | (%), batch 2, | (%), batch 3, | (%), batch 4, |
| Metal type | (° C.) | 3000 Nm | 3000 Nm | 3000 Nm | 3000 Nm |
| Silicone nitride | 1800 | 63 | 65.6 | 61.6 | 69.4 |
| Hydroxyapatite | 1600 | 70.7 | — | — | — |
| Alumina | 2050 | — | 71.6 | — | 71.2 |
| Zirconia | 2500-2600 | 78.1 | — | — | — |

Silicone Nitride SNE10 (from UBE)

Silicone nitride was tested in four different batches.

Solid silicone nitride is a non-oxidized ceramic and can be produced conventionally by liquid phase sintering to a completely densified material. Silicone nitride is a hard material, thermo- and corrosion resistant, with high fracture toughness. Silicone nitride has also a good resistance to wear and abrasion. It maintains strength and oxidation resistance at elevated temperatures, 1000-1100° C.

Common applications are crucibles, spray nozzles, tubes, cutting edges, jointing rings, ball bearings and engine parts.

Earlier test results have shown that it is more difficult to high-speed form ceramic powder compared with metal powder. The material body obtained was brittle and the density level reached 68%. Goals for pure silicone nitride powder is to obtain a solid material body with with a relative density level over 99%.

The results from four different batches are compared. One batch is pure powder, 2^{nd} bath is powder with processing additives, 3^{rd} batch is with sintering aid and the 4^{th} batch is with processing additives and sintering aid.

The powder in all four batches were pre-processed by granulation of a pure silicone nitride powder The granulation process used was freeze granulation.

The first sample of each batch was only pre-compacted with an axial load of 117680 N. The following samples, 26, 16, 11 and 15, respectively, in each of the batches, were first pre-compacted and thereafter compressed with one stroke.

The powder specified in Table 1 was used.

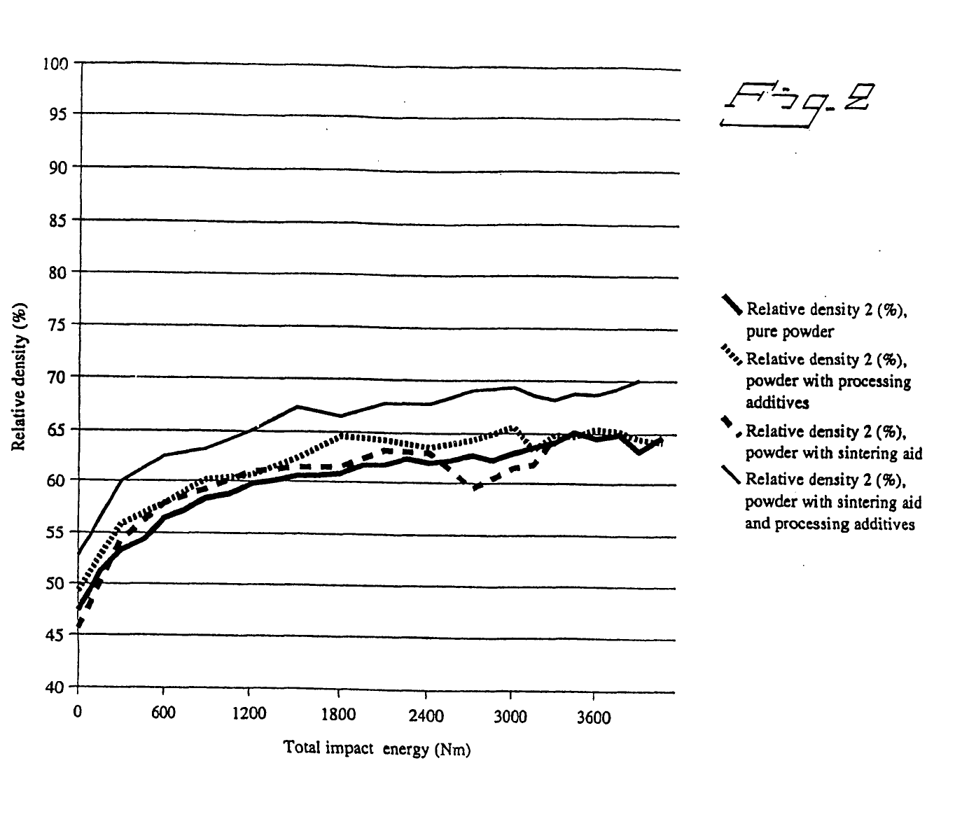

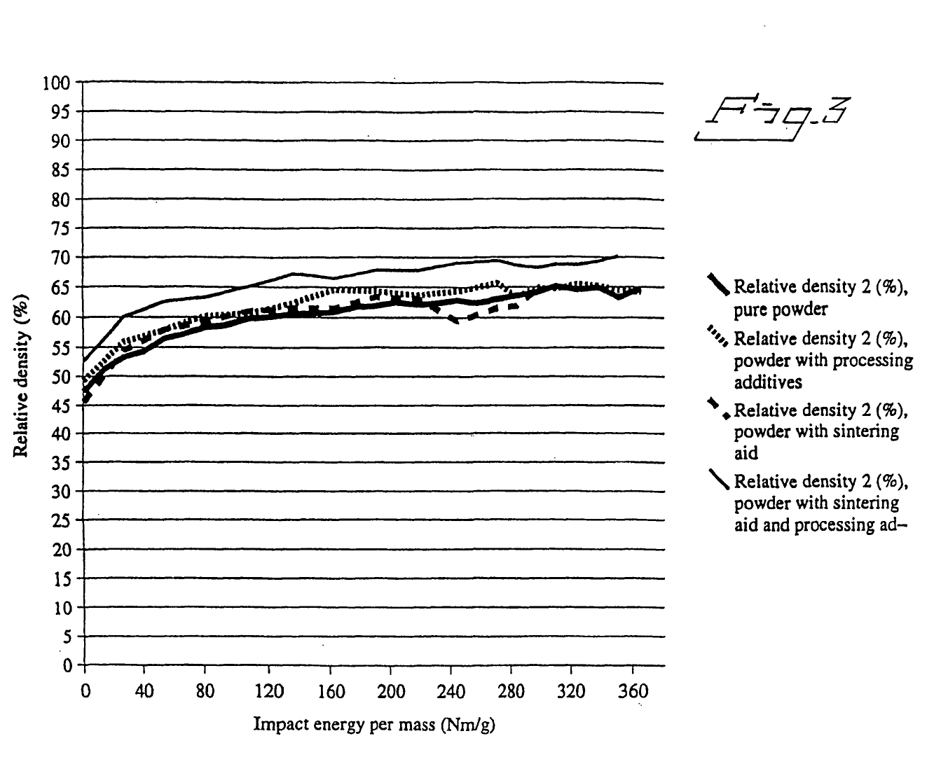

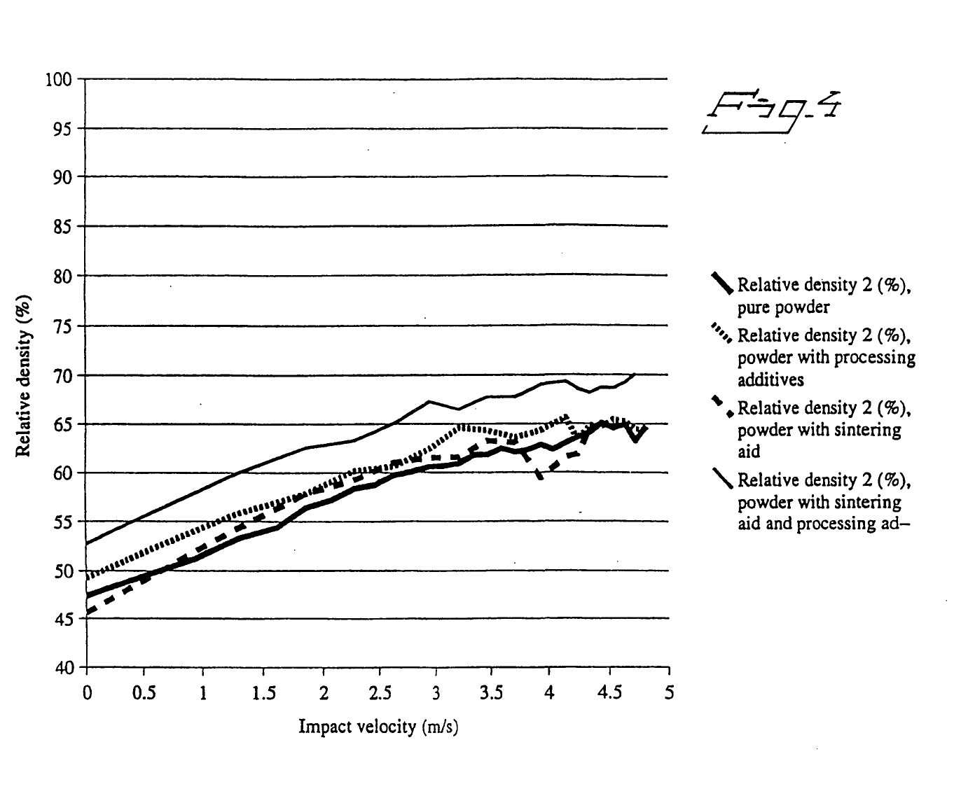

FIGS. 2-4 show relative density as a function of total impact energy, impact energy per mass and impact velocity.

All samples obtained from the four batches were brittle and had visibility index 2. Some of the samples fell apart directly after the removal and density 1 could not be measured, so density 2 should be studied. No notable phase change in any sample, they all seemed to be compressed powder. One notable difference was that samples in batches 2 and 4 which contained processing additives had a better green strength compared with the samples from batches 1 and 3.

The batch with pure powder was struck up to 4050 Nm (365 Nm/g, 4.8 m/s). All curves are smooth and increases slightly from 49.2-64.2% of relative density which corresponds to 0-310 Nm/g and 0-4.4 m/s, respectively. Then the inclination of the curve decreases and the the relative density is 65.1% for the highest impact energy level 4050 Nm (365 Nm/g, 4.81 m/s)

The batch containing processing additives was struck up to 4050 Nm (353 Nm/, 4.8 m/s). All curves are smooth and increases slightly from 49.0-64.6% of relative density which corresponds to 0-2100 Nm, 0-187 Nm/g and 0-3.2 m/s respectively. Then the inclination of the curve decreases and the the relative density is 65.6% for an impact energy level of 3150 Nm (279 Nm/g, 4.1 m/s).

Batch 3 contained only sintering aid and was struck up to 3000 Nm. All curves are smooth here as well and increases slightly from 45.7-61.0% of relative density which corresponds to 0-1200 Nm, 0-105 Nm/g and 0-2.6 m/s, respectively. From 2400 to 3300 the density 2 curves are irregular, probably because of the brittleness of the samples during measuring density 2. The curve increases to a relative density of 64.5% which is obtained with the highest impact energy level 3300 Nm (287 Nm/g, 4.3 m/s).

The powder containing processing additives and sintering aid reached the highest relative density and the finest samples. The curves are smooth and increases slightly from 52.7-65.1% of relative density which corresponds to 0-1500 Nm, 0-137 Nm/g. and 0-2.6 m/s respectively. Then the inclination decreases and the highest obtained relative density was 70.1% which is obtained with the highest impact energy level 4050 Nm (369 Nm/g, 4.7 m/s).

The relative density in this figure is between 45.7% (batch with sintering aid) and 70.1% (batch with both processing additives and sintering aid).

An impact energy range where the samples transform from powder to sample is not determined for any of the batches.

Out of these results there is no eventual peak of the relative density determined. The curves for batches 1, 3 and 4 reached their highest relative density at highest impact energy level.

Alumina (Al₂O₃) from Sumitomo

Alumina was tested in four different batches.

Solid alumina is an oxidized ceramic and can be produced conventionally by solid phase sintering to a completely densified material. Alumina is a chemical inert and stable in many environment. Alumina is corrosion resistant and has higher strength and wear resistant than porcelain, but less than e.g silicone carbide and silicone nitride. Alumina is a good electrical insulator and has at the same time an acceptable thermal conductivity. Due to its electrical insulator properties the material is used for producing substrates where electrical components are mounted, insulation for ignition plugs and insulation in the high-tension areas. Alumina is also a common material type in orthopaedic implants, e.g. femoral-head in hip prostheses.

Goals for pure alumina powder is to obtain a solid material body with with a relative density level over 99%.

The results from four different batches are compared. One batch is pure powder, 2^{nd} bath is powder with processing additives, 3^{rd} batch is with sintering aid and the 4th batch is with processing additives and sintering aid.

The powder used in batch 1 was a raw powder and was not pre-processed before the compacting process. The powders in batches 2-4 were pre-processed by granulation of a pure alumina powder. The granulation process used was freeze granulation.

The first sample of each batch was only pre-compacted with an axial load of 117680 N. The following samples, 19, 13, 16 and 16, respectively, for the four batches, were first pre-compacted and thereafter compressed with one stroke.

The aluminia powder tested had the properties given in Table 1.

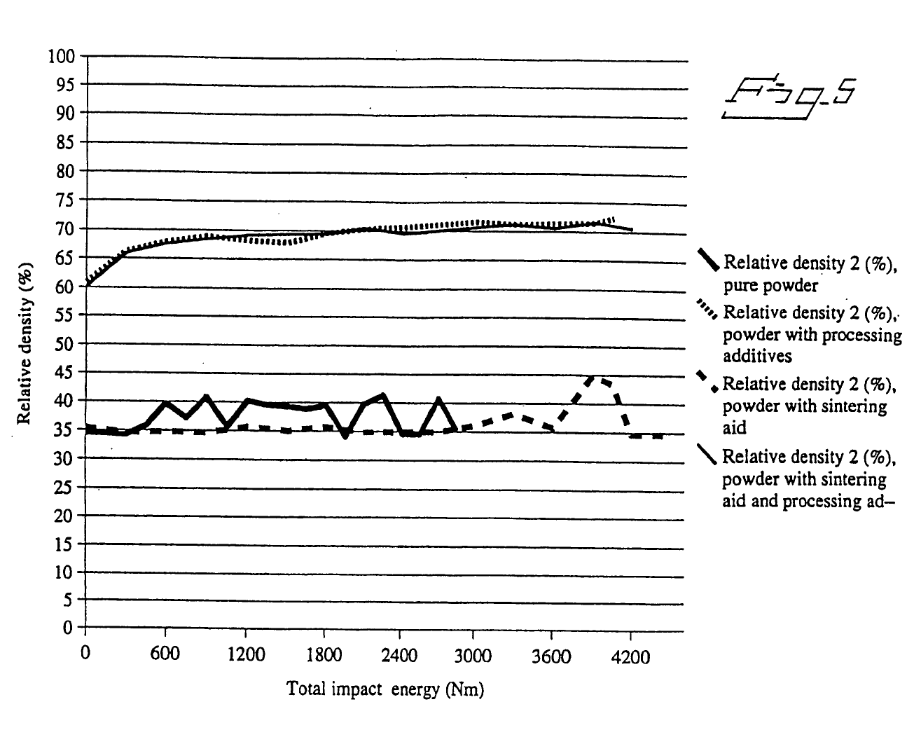

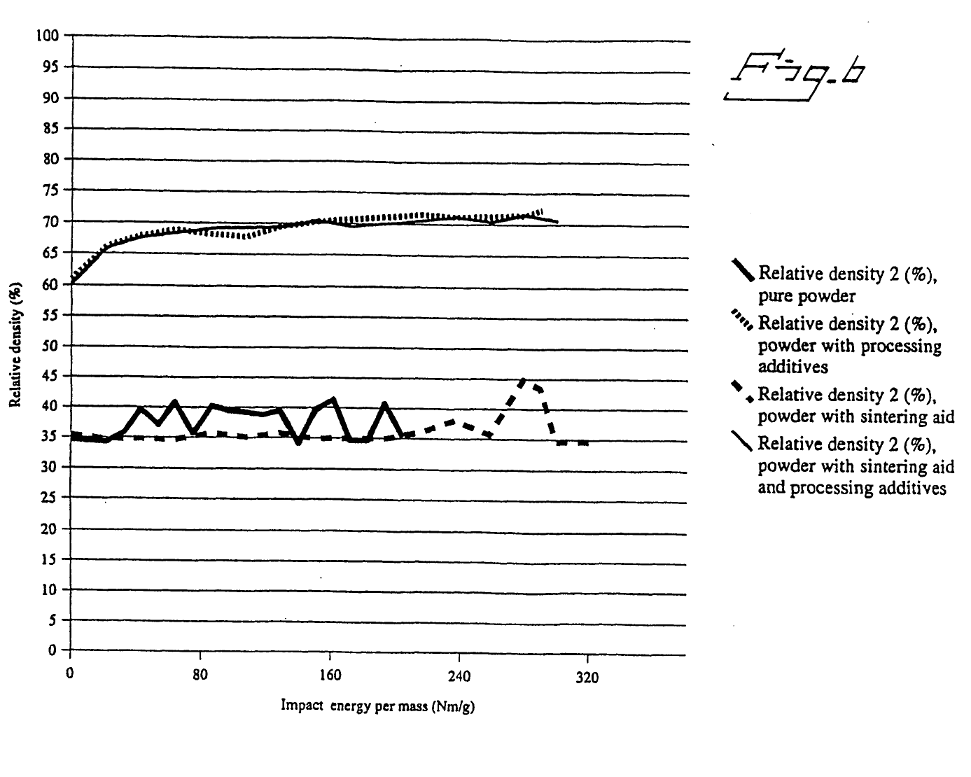

FIGS. 5 and 6 show the relative density as a function of total impact energy and impact energy per mass.

All samples obtained from the four batches were brittle and all samples from batch 1,3 and 4 had visibility index 1, while all samples except the pre-compacted sample for batch 2 were considered to have visibility index 2. The notable difference was that samples in batch 2 and 4 which contained processing additives had a better green strength compared with the samples from batch 1 and 3.

The samples in batch 2 and 4 did not fall apart as easily compared with the samples in batch 1 and 3, density 1 could therefore be measured for batch 2 and 4. No notable phase change in any sample, they all seemed to be compressed powder.

The batch with pure powder (not freeze-dried granulated) was struck up to 3000 Nm (215 Nm/g, 4.1 m/s). All curves are irregular and the highest obtained relative density is 41% for 2250 Nm (161 Nm/g, 3.6). The reason is that samples with low density absorbed water and cracks during measuring density 2. This phenomenon appears for all density 2 measurements and all batches. All values of density 2 have therefore to be consider approximately.

The batch containing processing additives was struck up to 4050 Nm (290 Nm/, 4.8 m/s). The curve for density 1 shows a ˜15% higher obtained relative density and a more smooth curve compared with the density 2 curve. The two curves were parallel which indicates the difficulty of measuring density 2. The curve for density 1 is thereforee the represented curve instead of density 2 in this case. The curves for density1 are smooth and increases slowly from 60.9% to 72.4% from the pre-compacting to 4050 Nm (0-290 Nm/g, 0-4.8 mIs). At 4050 is the highest relative density obtained for all four batches, 72.4%.

Batch 3 contained only sintering aid and was struck up to 4500 Nm (321 Nm/g, 5.1 m/s). All samples fell apart after removal from the tool so density 1 could not be measured properly.

The curve for density 2 is quite regular and the relative density does not increase with higher impact energies. The increase in relative density for sample 13^{th} and 14^{th} is probably also due to measuring faults.

The powder containing processing additives and sintering aid was struck up to 4200 Nm (300 Nm/g, 4.9 m/s). The curve for density 1 represents the curve and increases slowly from a relative density of 56.9% obtained by pre-compacting the powder to 71.6% which corresponds to 3900 Nm (278 Nm/g, 4.7 m/s)

An impact energy range where the samples transform from powder to sample is not determined for any of the batches.

All values for batch 1 and 3 are not representative for the curves because of the high insecurity in the measured values.

Out of these results there is no eventual peak of the relative density determined.

Hydroxyapatite Ca₂ (PO₄)₃ OH (HA) from Merck Eurolab

Solid HA is a water based ceramic material and is conventionally produced by different sintering techniques to a solid material.

HA is one of the most important biomaterials extensively used in orthopaedic surgery. It is a unique material that has a similar chemical composition as mineral tissue and is able to form a direct bonding with bone. Therefore, the implant made of HA will well integrate with bony tissue. However, there are several difficulties when producing this material, it will easy degrade at temperature higher than 1200° C. when the densification occurs for the traditional sintering technology; and the low mechanical strength of HA has been the obstacle for its use as a load-bearing implant. The development has been focusing on improving its strength by reinforcing this material using other ceramic powders or fibres and using polymers and metals

Earlier test results have showed that it is more difficult to high-speed form ceramic powder compared with metal powder. The material body obtained was brittle and the density level reached 80%. Goals for pure HA powder is to obtain a solid material body with with a relative density level over 99%. Due to the fact that the forming is not performed in an inert environment it may not be possible to reach a 100% relative density. However, porosity in a HA material does not have to be a disadvantage, because HA is used as bone replacement and the porosity gives the possibility of bone ingrowth in the material.

Pure HA is compressed to be used for implant applications and therefore was tested without any kind of material added which has toxic effects in the material body.

The powder used has not been pre-processed. Its properties are shown in Table 1. Powder production was by wet chemistry precipitation and granulation.

The first sample was only pre-compacted with an axial load of 117680 N. The following 19 samples were initially pre-compacted and thereafter compressed with one impact stroke. The impact energy in this series was from 150 and 3000 Nm with a 150 Nm impact step interval.

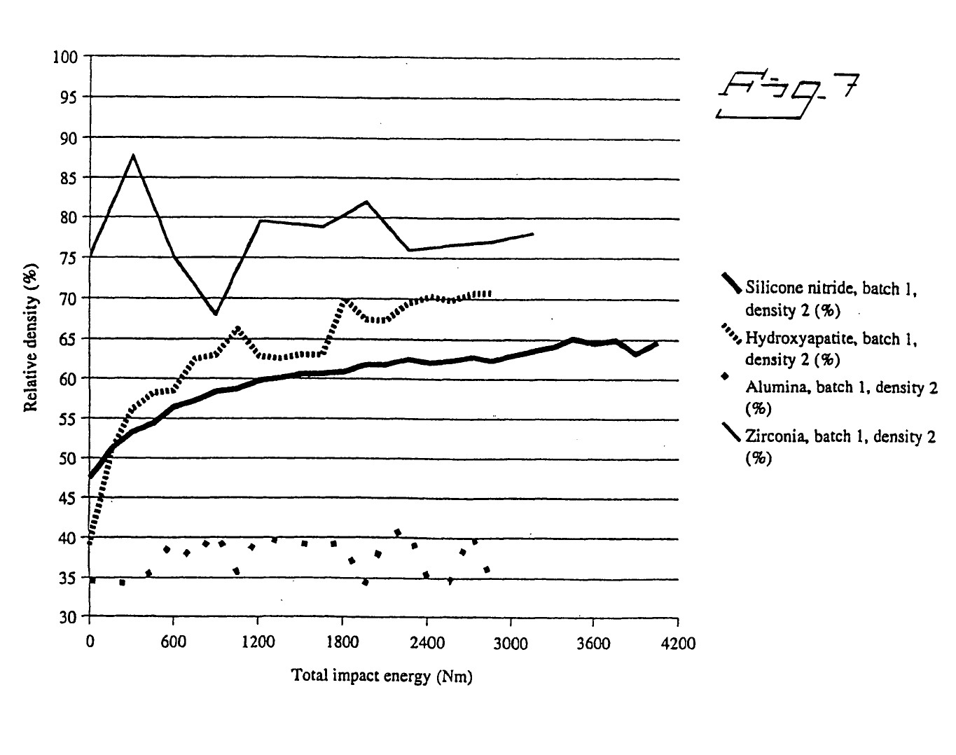

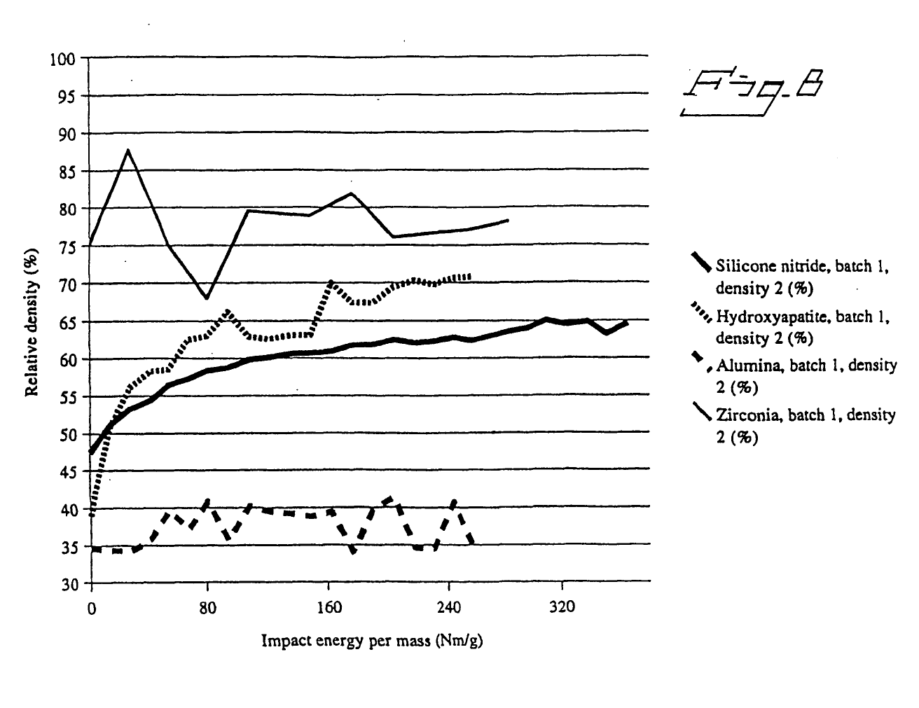

FIGS. 7 and 8 show relative density as a function of total impact energy and impact energy per mass for all four ceramics tested. The following described phenomena could be seen for all curves showing HA.

All samples between the pre-compacting and 3000 Nm (257 Nm/g, 4.1 m/s) had visibility index 2.

All samples were brittle when they were removed from the mould, it was therefore difficult to measure density 1. Some of the samples fell apart directly after the removal and density 1 could not be measured. All samples showed a change in phase. The colour of the samples increased in green/blue tone when the impact energy level increased.

Inspecting the FIGS. 7-8 the curves incline slowly from a relative density of 39.0% (pre-compacting) to 69.5% at 2250 Nm (203 Nm/g, 3.6 m/s) where the inclination decreases. The highest obtained relative density, 70.6%, was obtained at 2700 Nm.

Zirconia (ZrO₂) from Tosoh

Solid zirconia is an oxidized ceramic and can be produced conventionally by solid phase sintering to a completely densified material. Zirconia exists in one stabilised form and in partial stabilised form. The partial stabilised zirconia has a higher fracture toughness, strength and wear resistance than could be expected for an oxidized ceramic. Zirconia has also high thermal conductivity. Zirconia stabilised with yttrium is one of the strongest ceramic material that exists. However in an increased temperature decreases the high strength values. The strength starts to decrease already at temperatures over 300° C. Yttrium-stabilised zirconia is also sensitive to humidity in temperatures around 250° C. The magnesium-stabilised zirconia has lower strength, but does not show to be sensitive to neither humidity or temperature below 800° C.

Common applications for zirconia are metal tools, scissors, components to adiabatic engines and also a common material type in orthopaedic implants, e.g. femoral-head in hip prostheses.

Goals for pure zirconia powder is to obtain a solid material body with with a relative density level over 99%. As the forming is not performed in an inert environment it may not be possible to reach a 100% relative density.

Pure zirconia is compacted to be used for implant applications and was therefore be tested without any kind of material added which has toxic effects in the material body.

The powder used is described in Table 1. It was a raw powder and was not pre-processed before the compacting process.

The first sample was only pre-compacted with an axial load of 117680 N. The following 10 samples were initially pre-compacted and thereafter compressed with one impact stroke. The impact energy in this series was from 300 and 3000 Nm with a 300 Nm impact step interval.

FIGS. 7 and 8 show relative density as a function of total impact energy and impact energy per mass for all four ceramics tested. The following described phenomena could be seen for all curves showing zirconia.

All samples between the pre-compacting and 3000 Nm (289 Nm/g, 4.1 m/s) had visibility index 1.

All of the samples fell apart directly after the removal from the tool and density 1 could not be measured. No notable phase change in any sample, they all seemed to be compressed powder.

Density 2 is represented in the curves in FIGS. 7-8. All curves are irregular and the highest obtained relative density is 87.7% for 300 Nm (28 Nm/g, 1.3). The reason is that samples with low density absorbed water and cracks during measuring density 2. The values of density 2 have therefore to be consider approximately.

### Example 2

In the following parameter studies performed on silicon nitride and HA are described.

Multi stroke Sequence Parameter Study of Silicon Nitride (C-E)

Silicon nitride powder was compressed in different multi-stroke sequences ranging from two to six strokes with total energy levels from 2400 to 18000 Nm. The study is divided into two parts. The first study the sample's density as the total impact energy increases by adding the number of strokes. The individual stroke energy was 3000 Nm and performed from one to six strokes, i.e. the total impact energy was ranging from 3000 to 18000 Nm. Additional sequences were performed for the two stroke sequences with individual stroke energies of 1200, 2400, 3300 and 6600.

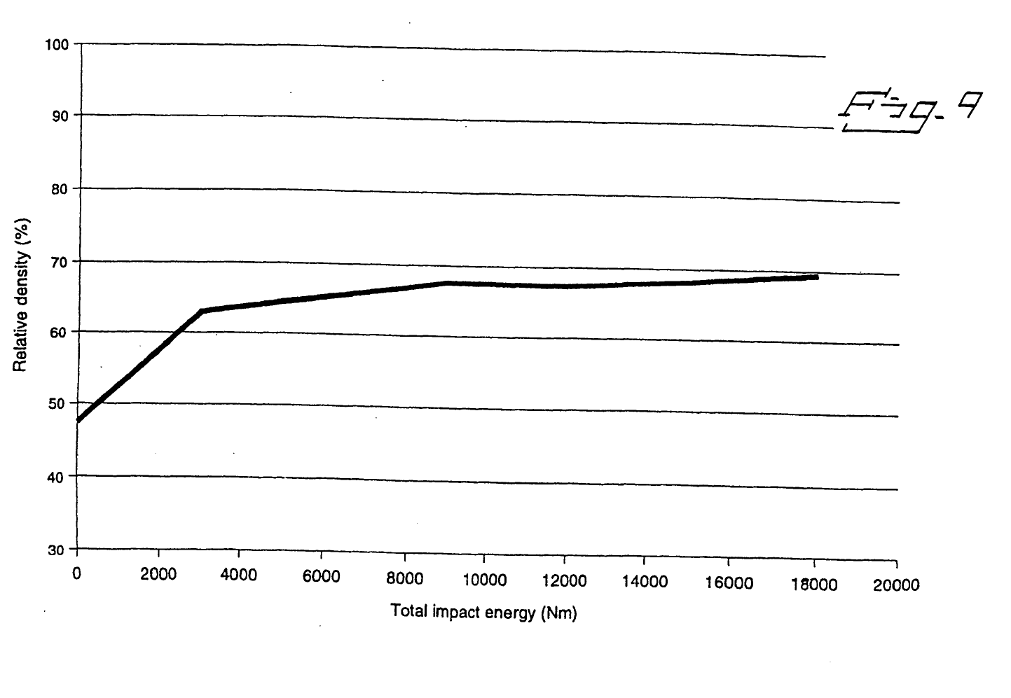

The results are shown i FIGS. 9-12.

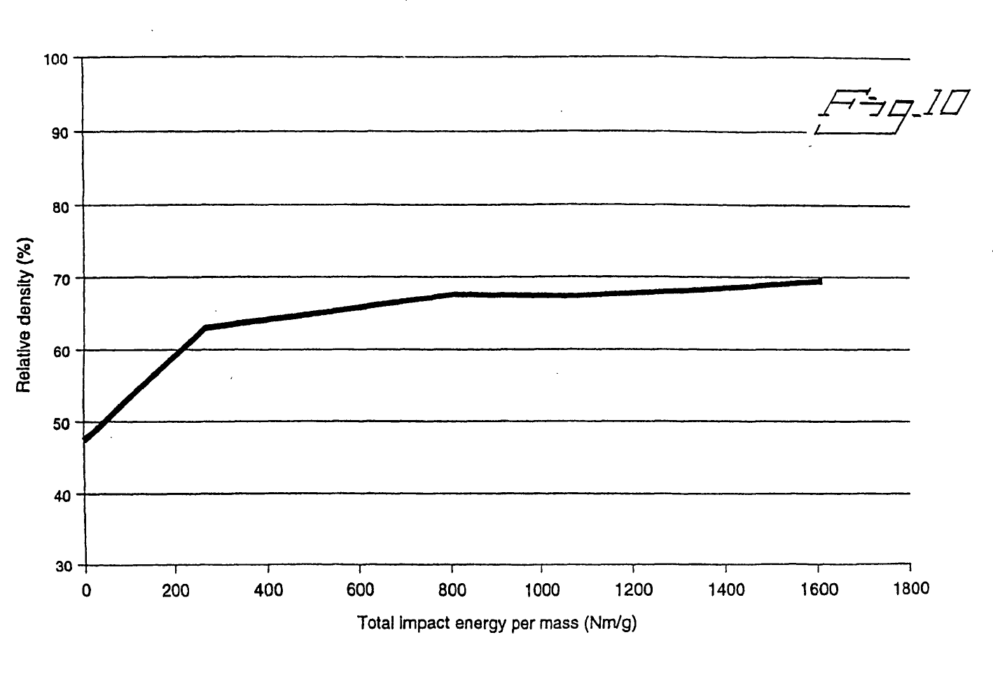

In FIG. 9 the relative density is plotted as function of total impact energy for the series with individual impact energy of 3000 Nm for one to six strokes. The total impact energy is the sum of the individual impact energy in a stroke series. FIG. 10 shows the same test series plotted as a function of total energy per mass.

The results show that most of the compaction occurs at pre-compaction and up to 3000 Nm. The increase in density from pre-compaction to 3000 Nm is 33%. This energy range was studied in Example 1. Total impact energy levels above 3000 Nm provides only for a minor increase in density. The increase in density between 3000 and 18000 Nm is 10% for a six-fold increase in energy.

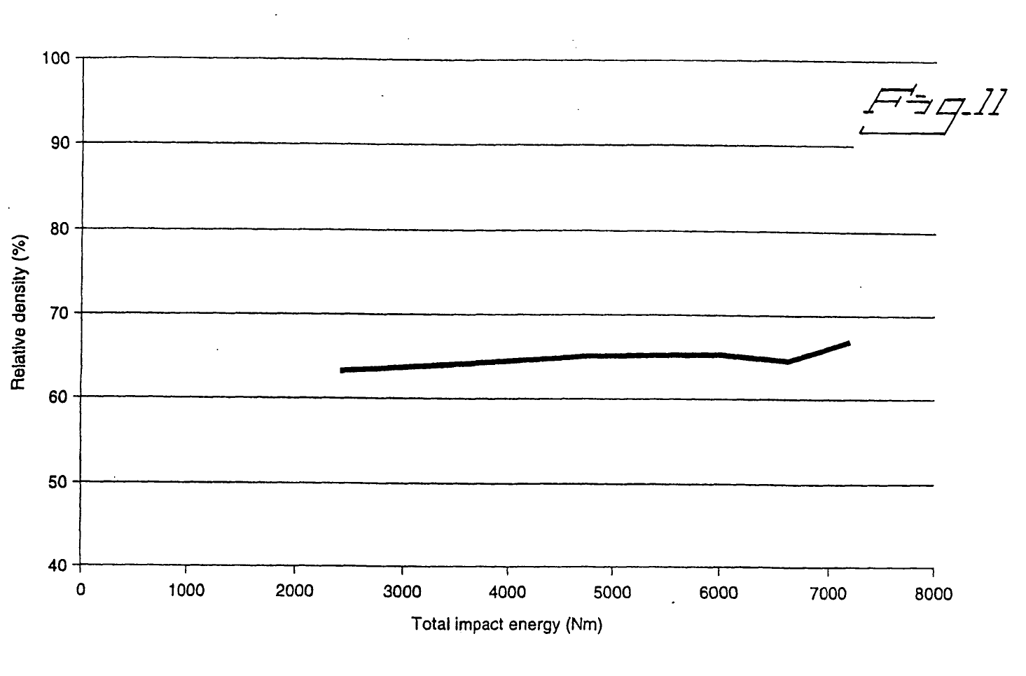

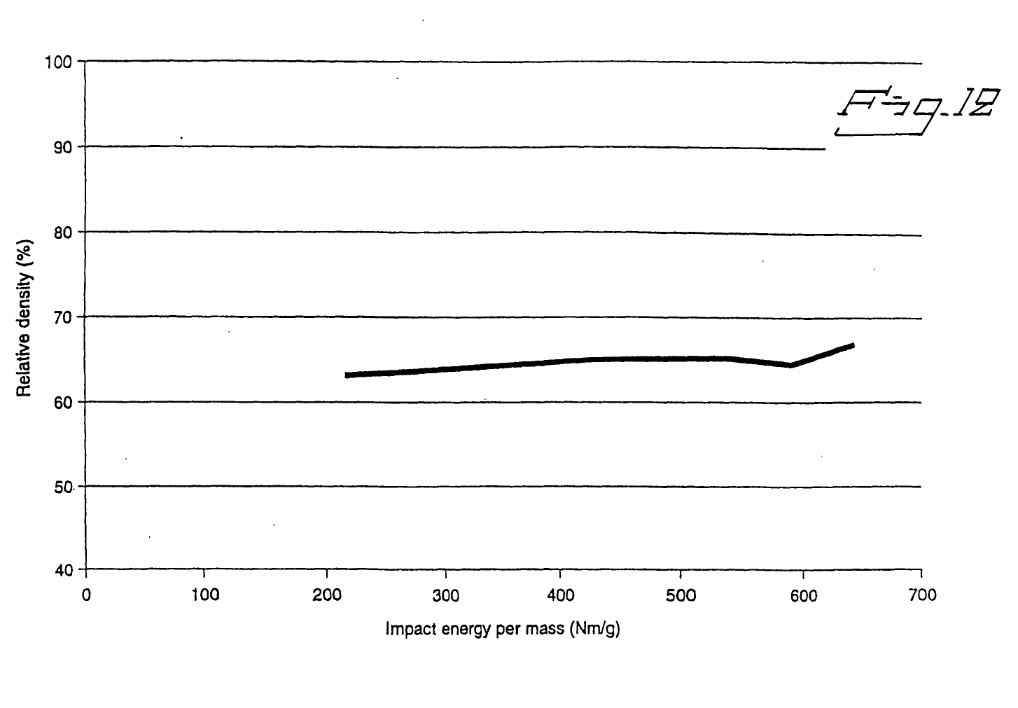

The two stroke study with the individual stroke energy half the total impact energy shows the similar behaviour. The increase in density is 6% for an increase in energy from 2400 to 7200 Nm, i.e. doubling the energy, see FIGS. 11, 12.

Inspecting the samples it could be seen that all the samples were very brittle and disintegrated into pieces as they were dismounted from the tool. However the samples had a very smooth and shiny surface before falling apart. The samples turned into a darker shade of beige as the energy increased. The densities given in the graphs for the samples produced is calculated using the density 2 method.

Mass Parameter Study of Hydroxyapatite (A)

Hydroxyapatite powder was compressed using three different sample weights, 2.8, 5,6 and 11.1 g. The 11.1 g sample series is the reference series described in Example 1. The 2.8 g and 5.6 g samples corresponds to a quarter and a half of the 4.2 g sample. The series were performed with a single stroke. The 11.1 g sample series were increased in steps of 150 Nm ranging from pure pre-compacting to maximum 3000 Nm of impact energy. The quarter weight and the half weight series were performed with increased energy level in steps of 300 Nm ranging from 300 to 3000 Nm. All samples per pre-compacted prior to the impact stroke.

In FIGS. 13 and 14 the three test series are plotted. The graphs show the relative density as a function of impact energy per mass and total impact energy. All relative density results given, are computed from the density 1 measurement method except for the 11.1 g series. The maximum relative densities reached, corresponding energy levels and the energy range are given in table 3.

Studying FIG. 13 it can be seen that the the three curves follow each other, which means that a certain density is obtained no matter of the specimen shape with respect to impact energy per weight. This also shown in FIG. 14 where density is plotted as a function of total energy. The curve is shifted to the left in the diagram for a lower sample mass. It could also be noted that higher density for the 11.1.g sample never reached the plateau density as indicated for the 2.8 and 5.5 g samples. The results show that the sample mass influences the density with respect to total impact energy, i.e. a larger sample mass needs more energy in order to obtain a certain density. The results also shows that there is a linear relation between mass and density with respect to impact energy per mass up to at least 271 Nm/g, see FIG. 13. Further the 11.1 g sample reached a lower pre-compaction at 39% in contrast to the other two which obtained a pre-compacting density of 48%.

TABLE 3

| | Sample weight (g) | | |
|---|---|---|---|
| | 2.8 | 5.6 | 11.1 |
| Number of samples made | 7 | 11 | 25 |
| Relative density at pre-compacting (%) | 48.3 | 48.5 | 39 |
| Minimum total impact energy (Nm) | 300 | 300 | 150 |
| Maximum total impact energy (Nm) | 1800 | 3000 | 3000 |
| Minimum impact energy per mass (Nm/g) | 106 | 53 | 14 |
| Maximum impact energy per mass (Nm/g) | 643 | 537 | 271 |
| Relative density at first produced body (%) | 48.3 | 49 | 39 |
| Impact energy at first produced body (Nm) | 0 | 0 | 0 |
| Maximum relative density 1 (%) | 78.6 | 79.2 | 70.8 |
| Impact energy per mass at maximum density | 537 | 537 | 271 |
| (Nm/g) | | | |

The samples turned from a light off white green to a darker shade as the energy increased. Also the middle of the sample had a more darker shade of green than the outer parts. The sample became more brittle as the energy increased and often fell into small pieces as it was removed from the tool.

Impact Velocity Parameter Study (A) of Hydroxyapatite (HA)

Hydroxyapatite powder was compressed using the HYP 35-18, HYP 36-60 and the High velocity impact machine in five test series with five different impact rams. For the high velocity impact machine the impact ram weight could be changed and three different masses were used; 7.5, 14.0 and 20.6 kg. The impact ram weight for the HYP 35-60 was 1200 kg and for the 35-18 it was 350 kg. The sample series performed with the HYP 35-18 machine is described in Example 1. All samples were performed with a single stroke and with a sample mass of 11.1 g. The series were performed for energies increasing in steps of 300 Nm ranging from pre-compacting to a maximum of 3000 Nm. All samples were also pre-compacted with an axial load before the impact stroke. The pre-compacting force for the HYP 35-18 was 135 kN, for the HYP 35-60 it was 260 kN and for the high velocity machine 18 kN. The highest impact velocity 28.3 m/s was obtained with the 7.5 kg impact ram and the slowest impact velocity, 2.2 m/s, was obtained with the impact ram mass 1200 kg, HYP 35-60 machine, at the maximum energy level of 3000 Nm.

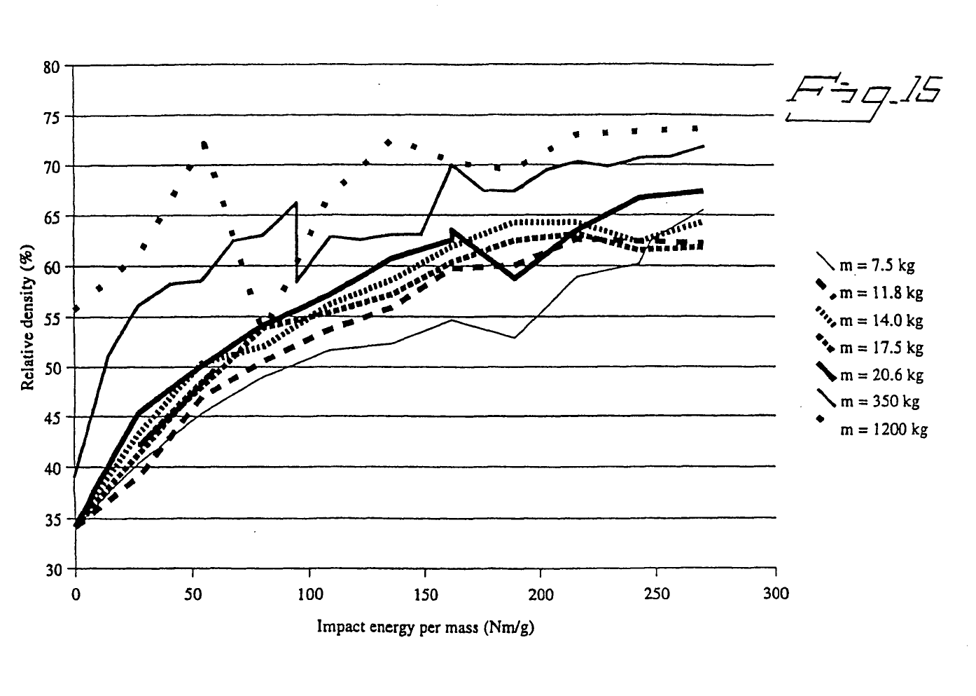

The results are shown i FIGS. 15-18.

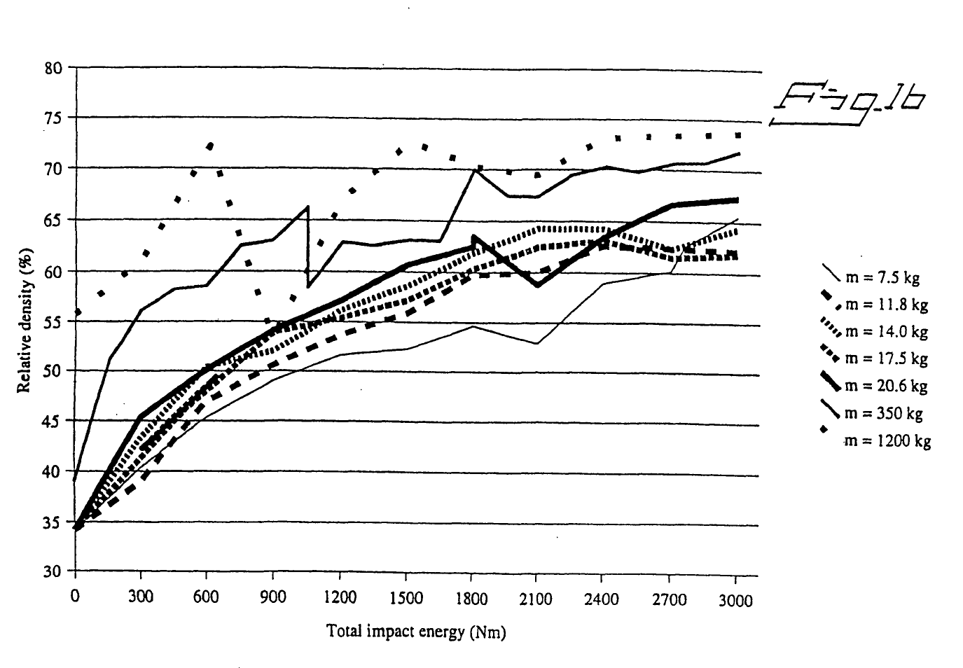

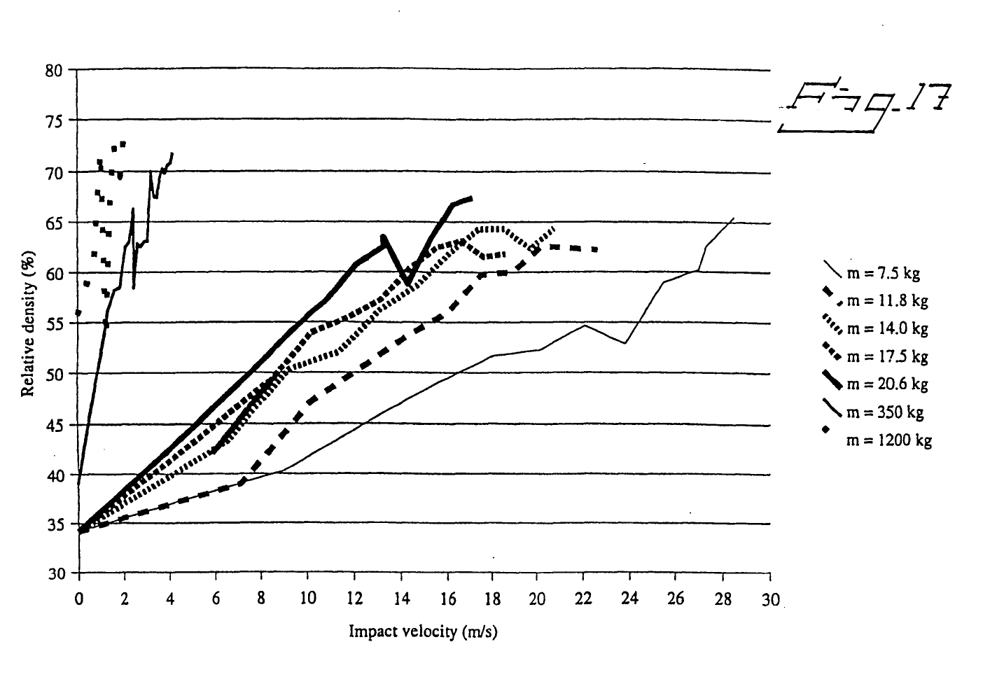

In FIG. 15 the five test series are plotted for relative density as a function of energy level per mass. FIG. 16 shows the relative density as a function of total impact energy and FIG. 17 shows the relative density as a function of impact velocity. The results are compiled in table 4.

TABLE 4

| | Machine ram weight (kg) | | | | |
|---|---|---|---|---|---|
| | 7.5 | 14 | 20.6 | 350 | 1200 |
| Sample weight (g) | 11.1 | 11.1 | 11.1 | 11.1 | 11.1 |
| Number of samples made | 11 | 10 | 12 | 32 | 11 |
| Relative density at pre-compacting (%) | 34.2 | 34.2 | 34.2 | 39.0 | 53.2 |
| Minimum total impact energy (Nm) | 300 | 300 | 300 | 150 | 300 |
| Maximum total impact energy (Nm) | 3000 | 3000 | 3000 | 3000 | 1800 |
| Minimum impact energy per mass (Nm/g) | 27 | 27 | 27 | 14 | 27 |
| Maximum impact energy per mass (Nm/g) | 270 | 270 | 270 | 270 | 270 |
| Relative density at first produced body (%) | 34.2 | 34.2 | 34.2 | 39.0 | 53.2 |
| Impact energy at first produced body (Nm) | 0 | 0 | 0 | 0 | 0 |
| Maximum impact velocity (m/s) | 28.3 | 20.7 | 17.1 | 4.1 | 2.2 |
| Maximum relative density (%) | 65.5 | 64.3 | 67.3 | 71.9 | 73.7 |
| Impact energy per mass at maximum density (Nm/g) | 270 | 270 | 270 | 270 | 270 |

The pre-compacted samples for the 7.5, 14.0 and 20.6 kg impact rams as well for the 350 and 1200 kg impact rams were not transformed to solid bodies, but to bodies easily breakable and brittle and described herein as visibility index 2. The density for the samples produced with 18 kN pre-compacting force the relative density was 34.2%. For the 135 kN and 260 kN pre-compacting force the density increased to 39.0 and 53.2% respectively. The relative density at pre-compacting is to a great extent dependent on the static pressure and shows the importance of the pre-compaction parameter for the total compaction result of the material. The results indicates that a higher density is obtained when the impact ram mass is increased or equivalent, a higher density is obtained when the impact velocity is decreased for a given energy level. The effect is decreasing with increasing energy level.

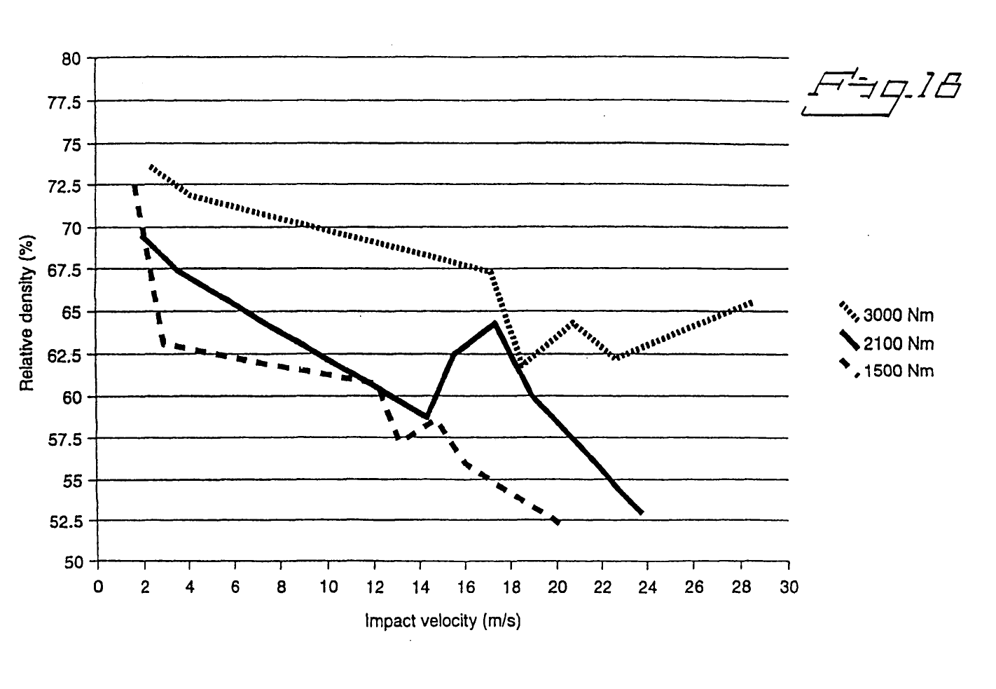

FIG. 18 shows the relative density as a function of impact velocity at three different total impact energy levels; 3000, 2100 and 1800 Nm, see also table 5 for the density values. The results shows that higher densities are obtained for the two heavier impacts rams, 350 kg and 1200 kg compared with the three impact rams used in the High velocity impact machine. For instance, the density is increased by 13% comparing the samples made using the 7.5 kg impact ram with the 1200 kg impact ram at a total impact energy level of 3000 Nm. At the same time the impact velocity is decreased from 28.5 to 2.2 m/s. Comparing the three impact weight rams 7.5, 14.0 and 20,6 kg, little or no increase in density could be identified for the 3000 Nm energy level. However, for the 1500 Nm level a trend may be seen giving a higher density for a decreased impact velocity.

The density-energy curves in FIG. 15 and FIG. 16 show that a higher impact ram weight has a larger initial slope than for the low impact weight. Consequently, a low impact speed gives a faster increase in density compared to high impact speed at the same energy level. At higher energy levels the gap between the curves is decreased. This could also be seen in FIG. 18 as a curve with a smaller slope for the 3000 Nm energy level compared with the 2100 and 1500 Nm energy levels.

Inspecting the samples it could be see that they were different in shape and colour depending on the impact ram weight and the impact speed. Generally for all different impact rams the samples changed colour from an off white with a pale green tone for the pre-compacted sample to a darker green shade as the impact energy increased. Further, the pre-compacted sample were more inclined to hold together than the samples produced at higher energy levels. The samples became more brittle as the energy increased. Samples produced with a heavier impact ram or decreased impact velocity for a certain energy level became more brittle and turned more green than for the samples produced at a higher impact velocity using a impact ram of lower mass.

The densities given for the samples produced with the 1200 kg impact ram is calculated using the density 1 method. The reason for this was that these samples were very brittle and came apart during the density 2 operation and only the five first samples at the lower energies could be measured. One measuring point at 611 Nm is used from the density 2 results because the obtained body was to irregular and could not be measured using micrometers. For the other series the density is given based on the density 2 method.

TABLE 5

| Impact | | | | | | |
|---|---|---|---|---|---|---|
| energy | | | | | | |
| Impact | 3000 Nm | | 2100 Nm | | 1500 Nm | |
| ram | Impact | Relative | Impact | Relative | Impact | Relative |
| weight | velocity | density | velocity | density | velocity | density |
| (kg) | (m/s) | (%) | (m/s) | (%) | (m/s) | (%) |
| 7.5 | 28.5 | 65.5 | 23.8 | 52.9 | 20.1 | 52.3 |
| 14 | 20.7 | 64.3 | 17.3 | 64.3 | 14.7 | 58.6 |
| 20.6 | 17.1 | 67.3 | 14.3 | 58.7 | 12.1 | 60.7 |
| 350 | 4.1 | 71.9 | 3.5 | 67.4 | 2.9 | 63.1 |
| 1200 | 2.2 | 73.7 | 1.9 | 69.5 | 1.6 | 72.6 |

Impact Velocity Parameter Study (B) of Silicon Nitride

Silicon nitride powder was compressed using the HYP 35-18 and the High velocity impact machine with a impact ram of 20.6 kg. The impact ram weight for the HYP 35-18 was 350 kg. The sample series performed with the HYP 35-18 machine is described in Example 1. All samples were performed with a single stroke and with a sample mass of 11.2 g. The series were performed for energies increasing in steps of 300 Nm ranging from pre-compacting to a maximum of 3000 Nm. All samples were also pre-compacted with an axial load before the impact stroke. The pre-compacting force for the HYP 35-18 was 135 kN and for the high velocity machine 18 kN. The maximum impact velocity for the 20.6 kg impact weight was 17.1 m/s and 4.1 n/s, was obtained with the impact ram mass 350 kg, HYP 35-18 machine, at maximum energy level 3000 Nm.

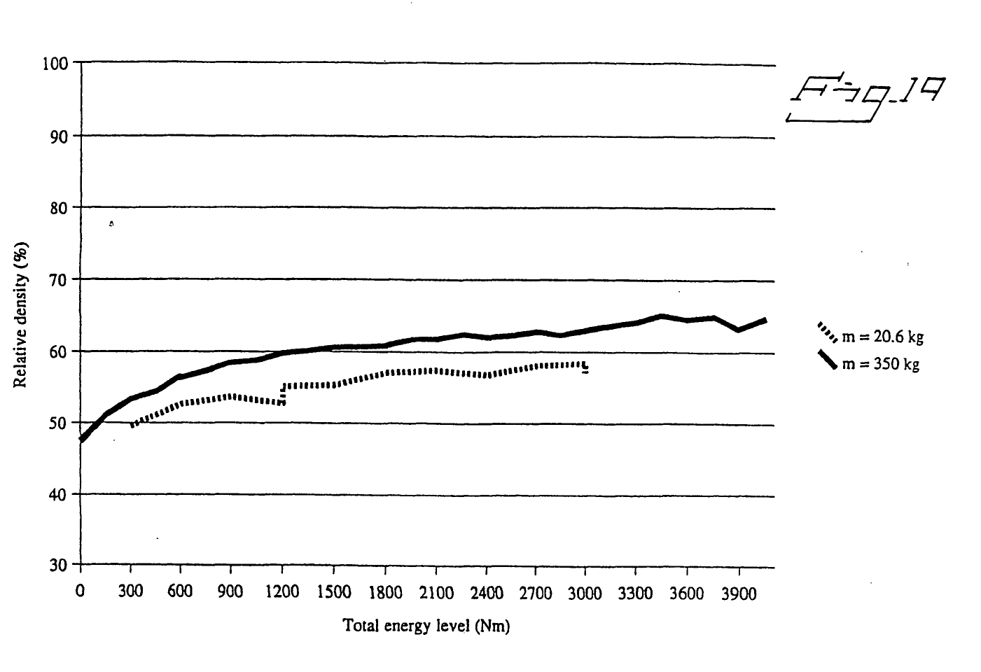

The results are shown on FIGS. 19-21.

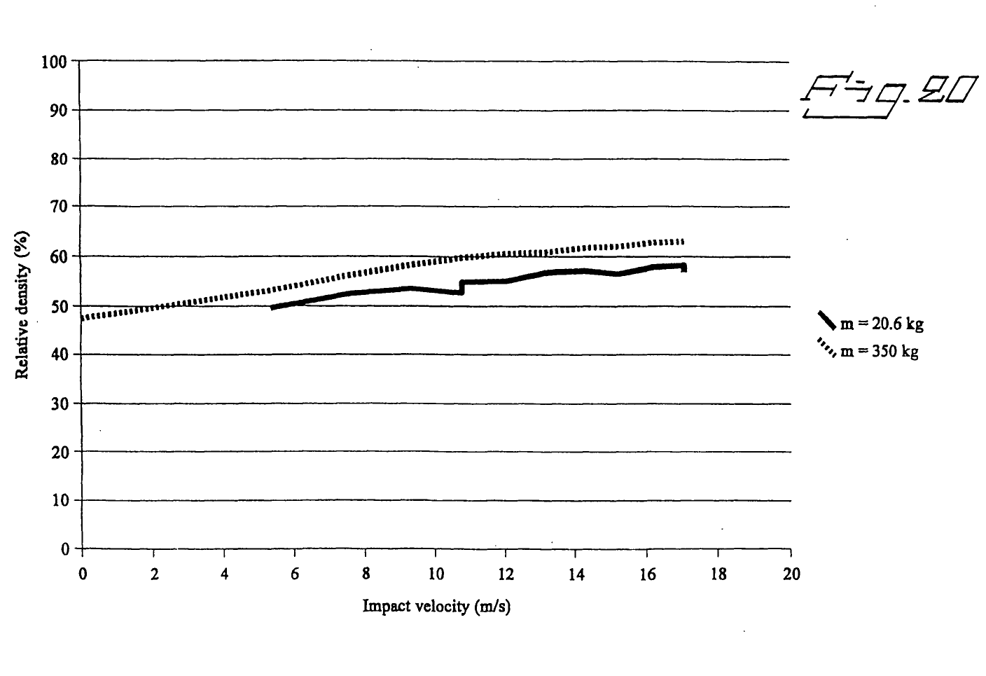

In FIG. 19 the five test series are plotted for relative density as a function of total energy level per mass. FIG. 20 shows the relative density as a function of impact velocity. The results are compiled in table 2.

No pre-compacted samples were made with the 20.6 kg ram. All samples made were easy breakable, brittle and described herein as visibility index 2. The results indicates that a higher density is obtained when the impact ram mass is increased or equivalent, a higher density is obtained when the impact velocity is decreased for a given energy level. This effect obtained at lower velocities is decreasing with increasing energy level.

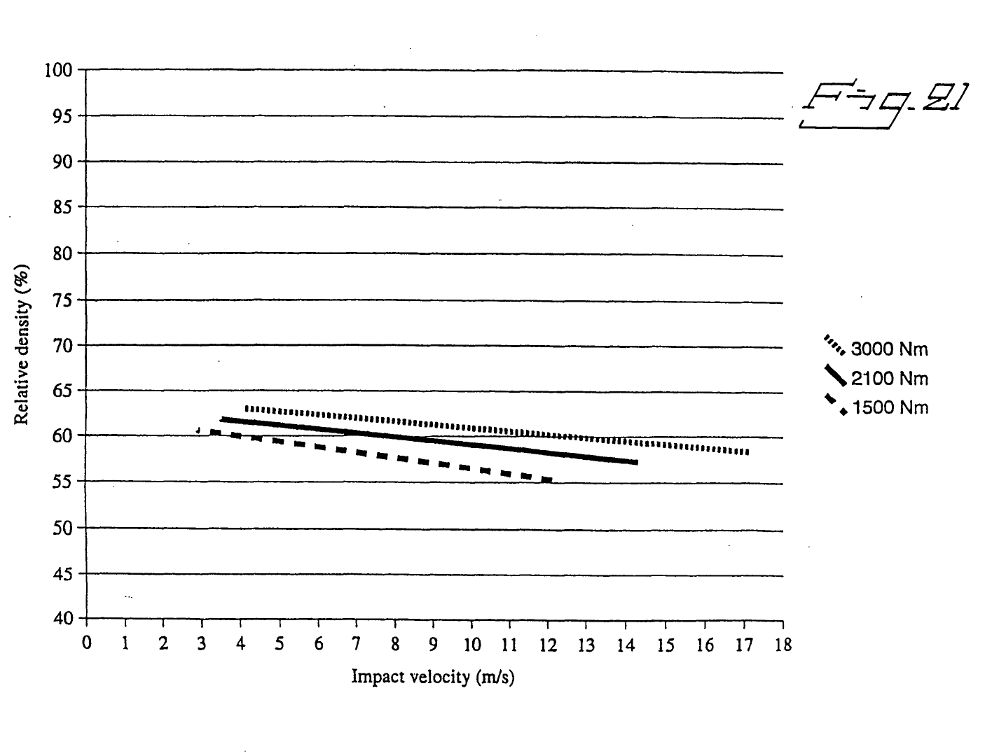

FIG. 21 shows the relative density as a function of impact velocity at three different total impact energy levels; 3000, 2100 and 1500 Nm, see also table 7 for the density values. The results show that higher densities are obtained for the heavier impacts ram, 350 kg, compared with the 20.6 kg impact ram used in the High velocity impact machine. For instance, the density is increased by 8% comparing the samples made using the 20.6 kg impact ram with the 350 kg impact ram at a total impact energy level of 3000 Nm. At the same time the impact velocity is decreased from 17.1 to 4.1 m/s.

TABLE 6

| | Machine | |
|---|---|---|
| | ram weight (kg) | |
| | 20.6 | 350 |
| Sample weight (g) | 11.2 | 11.2 |
| Number of samples made | 10 | 29 |
| Relative density at pre-compacting (%) | — | 47.4 |
| Minimum total impact energy (Nm) | 300 | 150 |
| Maximum total impact energy (Nm) | 3000 | 4050 |
| Minimum impact energy per mass (Nm/g) | 27 | 14 |
| Maximum impact energy per mass (Nm/g) | 268 | 365 |
| Relative density at first produced body (%) | 49.6 | 47.4 |
| Impact energy at first produced body (Nm) | 300 | 0 |
| Maximum impact velocity (m/s) | 17.1 | 4.8 |
| Maximum relative density (%) | 57.0 | 65.1 |
| Impact energy per mass at maximum density (Nm/g) | 268 | 310 |

Inspecting the samples it could be see that samples became more brittle as the energy increased. Samples produced with a heavier impact ram or decreased impact velocity for a certain energy level became more brittle and turned more darker than for the samples produced at a higher impact velocity using a impact ram of lower mass. The densities given in the graphs for the samples produced is calculated using the density 2 method.

TABLE 7

| Impact | | | | | | |
|---|---|---|---|---|---|---|
| energy | 3000 Nm | | 2100 Nm | | 1500 Nm | |
| Impact | Impact | Relative | Impact | Relative | Impact | Relative |
| ram | velocity | density | velocity | density | velocity | density |
| weight (kg) | (m/s) | (%) | (m/s) | (%) | (m/s) | (%) |
| 20.6 | 17.1 | 58.4 | 14.3 | 57.3 | 12.1 | 55.3 |
| 350 | 4.1 | 63 | 3.5 | 61.8 | 2.9 | 60.6 |

Heat Study (F) Silicone Nitride and Alumina

Two materials were tested in the pre-heat study, silicone nitride and alumina. These powders have been difficult to compact properly and to high densities.

The goal with the heat testing was to evaluate how a pre-heating of different materials affect the compacting process and density of the sample.

The powder was first pre-heated to 210° C. for 2 hours, to obtain an even temperature in the powder. Then the powder was poured into a room tempered mould and the temperature of the powder was measured during the pouring into the mould. As fast as possible the tool was mounted and the powder pre-compacted with an axial load of 117680 N and struck between 300 to 3000 Nm.

Properties of the powders used are given in Table 1.

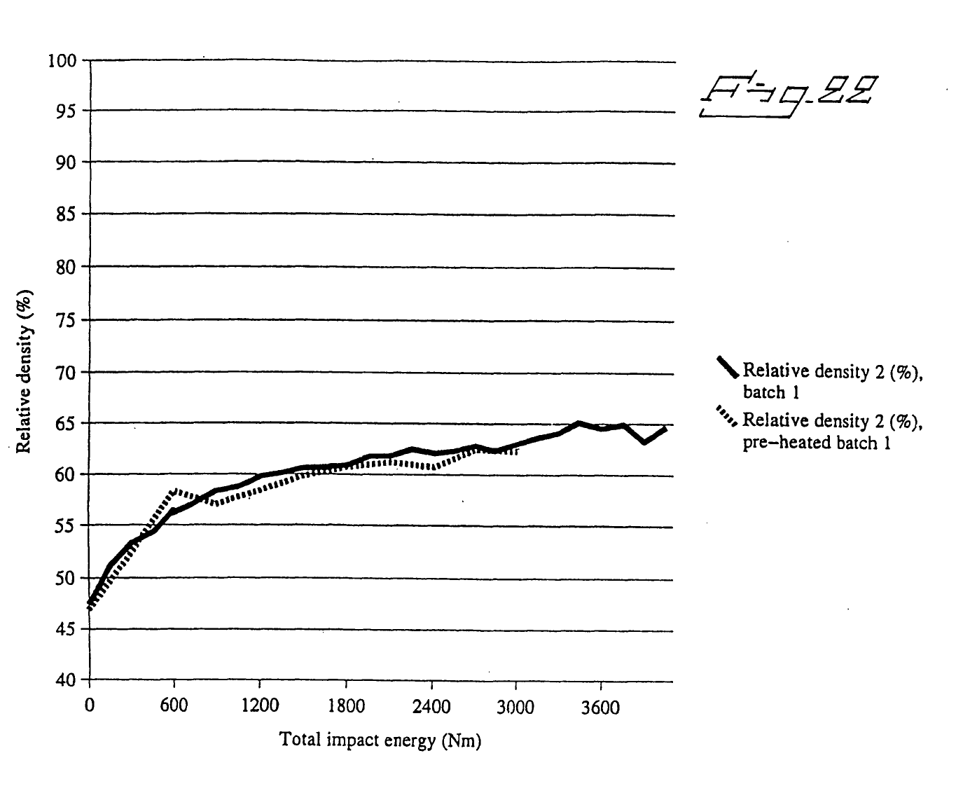

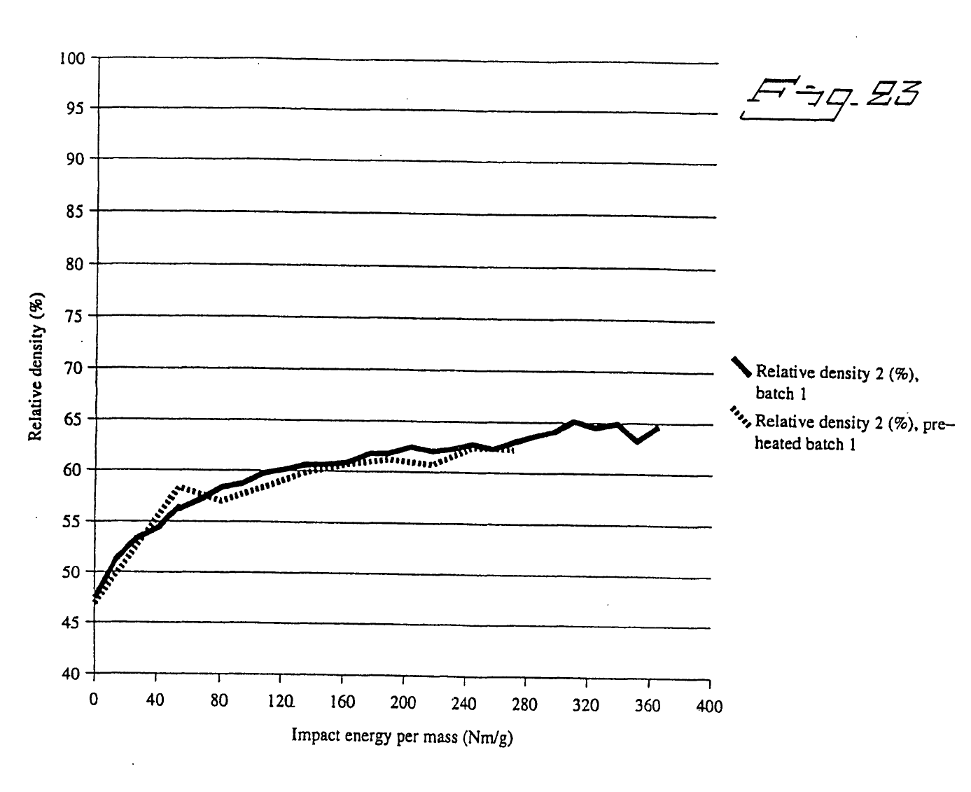

FIGS. 22 and 23 show relative density as a function of total impact energy and impact energy per mass. The results obtained are also shown in Table 8.

The powder had a temperature between 150-180° C. before compacting.

The two curves follow each other and the relative density for the pre-heated powder is sometimes less compared with the non pre-heated powder. The highest obtained density for the pre-heated powder was 62.4% at 2700 Nm (244 Nm/g, 3.9 m/s) compared with 62.8% for the non pre-heated samples at same impact energy and impact velocity.

All samples obtained were brittle after removal from the tool and had visibility index 2.

TABLE 8

| | Non pre-heated | Pre-heated |
|---|---|---|
| | Silicone nitride | Silicone nitride |
| Sample weight (g) | 11.2 | 11.2 |
| Number of samples made | 27 | 11 |
| Relative density 2 (%) obtained for pre- | 49.2 | 46.9 |
| compacting | | |
| Minimum impact energy (Nm) | 150 | 300 |
| Maximum impact energy (Nm) | 4050 | 3000 |
| Impact energy step interval (Nm) | 150 | 300 |
| Maximum impact energy per mass (Nm/ | 330 | 271 |
| g) | | |
| Relative density 2 of first obtained body | 49.2 | 46.9 |
| (%) | | |
| Maximum relative density 2 (%) | 65.1 | 62.4 |
| Impact energy at maximum relative | 3450 | 2700 |
| density 2 (Nm) | | |

Alumina was also tested. Unfortunately all the alumina samples cracked during density 2 measuring and no representative result could be obtained. This was the same phenomenon as for the non pre-heated test batch.

There was less material coating in the tool after compacting a pre-heated silicone nitride or alumina powder.

The external lubrication of the tool is a polymer dispersion, Acrawax C, which has a melting temperature of ˜120° C. During the compacting the polymer melted and the mould became coated with a plastic film. This was probably the reason for the decrease in material coating in the tool after compacting ceramic materials.

Conclusions

The melting temperature and particle hardness seems to affect the grade of densification of the material. For instance the melting temperature and particle hardness for stainless steel powder is ˜500 and 10 times lower respectively compared with e.g silicone nitride.

Silicone nitride is a two-phase material which means that the surface of a silicone nitride powder particle have a thin layer of SiO₂, which decreases the particle hardness and soften the powder particle. This is probably the reason for the better condition of the silicone nitride samples compared to alumina and zirconia samples which are one-phase ceramics.

The grains in a ceramic material cannot be deformed plastically like a metal grain. If a grain is plastically deformed it can get closer to the other grains and force the air out of the powder.

Silicone nitride is a liquid phase sintered ceramic and during sintering SiO₂ goes into a solution which can be formed if enough air is forced out from the powder and the temperature has reach a certain value. The binders in the granulated powder helps to create this melt. The melt works as a driving force to force the air out of the powder. The alfa grains goes into a solution and are out crystallised to beta grains. Without the melt its impossible to form alfa grains to beta grains. When both Al₂O₃ and Y₂O₃ are used as sintering aids for silicone nitride, the ceramic reacts with SiO₂ and forms this glass phase at 1300° C. instead of at 1800° C. which is the case for a pure powder. If the powder only contains Y₂O₃ the sintering temperature is increased to 1600° C. Zirconia grains can be plastically deformed at a temperature of 1100-1200° C. due to the lower particle hardness compared to the other ceramics.

When an alumina powder is densified to 100% density is it not by forming a glass phase like silicone nitride. Alumina is a solid phase sintered ceramic which means that there is a material transport during the densification. In grain boundaries small grains are vaporised onto bigger grains. Small grains has a higher surface activity which makes them react easily which probably is the ideal in a fast compacting process. In a sintered sample of alumina direct bonding between the grains can be seen, but often with defects and the bonding structure is not perfect even though the density has reached 100%.

When the samples started to smell burnt this was probably due the polymeric binders that were vaporised at high impact energies.

Compared with the other three tested ceramics (silicone nitride, alumina and zirconia) hydroxyapatite showed the best results, even though the relative density did not reach over 80%. Hydroxyapatite is the only ceramic where a clear phase change has visually been noted. The reason is probably that hydroxyapatite has a greater amount of ion-bonding which is a weaker bonding compared with a covalent bonding. The samples are very brittle and increasing the impact energy does not seem to be a solution to reach higher densities. The only thing that occurs is that the samples fall apart into even smaller pieces. Hydroxyapatite has a melting temperature of 1600° C. and a hardness of 450 HV, which is lower compared with the other tested ceramics e.g zirconia (2050° C. and 1250-1350 HV). But higher compared with stainless steel (1427° C. and 160-190 HV). This could explain why hydroxyapatite can be compressed more easily compared with other ceramic materials, which supports the theory of the melting temperature and particle hardness influence on the grade of compaction.

Due to transmitted energy a local increase in temperature occurs, and that enables the particles to soften, deform and the surface of the particles to melt. This inter-particular melting enables the particles to re-solidify together and dense material can possibly be obtained.

The goal when a powder is compressed is to reach a sufficient impact energy for two powder particles to coalescence which can be described as an inter-particular melting. The result is a phase change in the material when more particles forms a solid material body. In a conventional powder processing the whole particle melts including the core. During a high-speed compacting the powder particle only melts on the surface, which makes the rest of the powder particle unaffected. When the particles melt it is possible to obtain a chemical bonding between them. This is what happens when metal particles are compressed, but “chemical bonding” is a misleading word concerning reaction in a ceramic powder. Ceramics particles lie like in a sea of glass phase compared with metals which have an oxide layer, and eventually a rest product between the particles, which means that there is no chemical bonding between the ceramic powder particles. It is probably easier to compact a ceramic material with small particles during a fast lapse of increased temperature. If the powder particles are to big the only thing that will happen is that the particles cracks to smaller particles instead of reacting and melt together. Small grains give a higher strength in the material body, but decreases the fracture toughness.

If there are covalent bonds between two ions (e.g. between Si and Ni), high energy level is required to start a decomposition process. The electron cloud are not in between the two ions. Instead they are dislocated further to one of the ion. If there is an ion bond (metal bond) the electron cloud is between the two ions and a lower energy level is required. Therefore silicon nitride and other ceramic powder, that have covalent bonding, might be more difficult to solidified.

Due to the high melting temperature and hardness of a ceramic material is it probably necessary to decrease the energy required to form a solid material body, which is possible by pre-heating the powder and process the whole compacting process in a surrounding with raised temperature above 500° C., which could be concluded after the heating study. The hole process should be made in a raised temperature. The pre-heating will also remove humidity in the powder and soften possible added binders. Probably is also an atmosphere e.g vacuum necessary to avoid eventual air inclusions in the material.

The granulation of the pure powder seemed to have an positive effect for the compacting process of a ceramic powder. The samples were brittle but did not fall apart as easily as a pure compressed silicone nitride powder, which was tested in an earlier screening test. There is one binder in the granulated ceramics containing processing additives (batch 2 and 4), to render strength to the material and one softening aid to make the constitution more soft. This softening supports the sliding of the particles during the compression process. The binders have probably only worked like a glue between the particles instead of creating a phase change in the samples.

With cold isostatic pressing a relative density of 70% is obtained, which means that irrespective of the achieved ceramic material body after the compacting process having reached 100% relative density or only 80%, the level is higher compared with densities after conventionally PM. By starting with a 80% densified material it is possible to decrease the degree of shrinking and the dimension tolerance increases during sintering. This means that it will be easier to control the dimensions of the final product. Normally a ceramic material can shrink 20% during sintering, with the present technique it may shrink only 10%. An increase in material properties and densities is obtained.

However, the fast process can also cause a different microstructure. Depending on how the particles are deformed, the configuration of the particles can change in different directions. This means that the material has different properties (electrical- and thermal conductivity, wear properties e.g.) in different parts of the material body. This can also mean that it is possible to create new materials with different material properties.

To reach the highest densities HIP (Hot isostatic pressing) technique is used which is an expensive process compared with less complicated sintering methods.

The granulated powder containing both processing additives and sintering aid did achieve a better result compared with the other tested silicone nitride powders. Conventionally sintered ceramic samples contains both processing additives and sintering aid, and it is possible that if the samples from batch 4 are sintered the result will reach higher densities and better material properties compared with the samples from batch 1-3.

Changing the pre-compacting procedure for a metal powder has given positive results, this may also be the case for ceramic powders. Several pre-compacting steps could force more air out of the powder before compressing and a post-compacting isolates the transmitted energy from the striking unit which makes the local increase in temperature affect the powder particles for a longer period of time.

### Example 3

The tests were performed with hydroxyapatite.

When a sample is produced it must automatically and quickly be dismounted from the tool. Thereafter the next sample should be produced, without the need of any preparation, like polishing, of the tool surfaces. In the above tests the used lubricant, Acrawax C, rendered material rests on the tool surfaces at high impact energies for some material types.

There will also be tested how different lubricants affect the obtained relative density. According to the literature the friction against the tool walls causes a pressure fall from the moving stroke unit and that decreases the compression of the powder and correspondingly also the density.

Several types of lubricants are tested. The amount of graphite, two types of graphite, the amount of boron nitride in grease, the viscosity are all tested to determine the behaviour of each parameter.

The powder used has not been pre-processed.

Each lubrication type was applied on the tool surfaces. The first sample in some batches were pre-compacted with an axial load of 117680 N and some not. The following samples were initially pre-compacted and thereafter compressed with one impact stroke. The impact energy in these series were different depending on the amount of material left on the tool surfaces. Each test started at 300 and increased with a 300 Nm impact step interval.

To easier establish the state the required cleaning of the tool, after a sample had been produced, six stickiness indexes are used. The description of each stickiness index is described in table 9

TABLE 9

| Stickiness | |
|---|---|
| index | Description |
| 0 | Wipe the tool surfaces with a dry rag |
| 1 | Wipe the tool surfaces with acetone |
| 2 | Polish with an emery cloth < 1 minute |
| 3 | Polish with an emery cloth 1-10 minutes |
| 4 | Polish with an emery cloth > 10 minutes |
| 5 | The tool needs to be removed to be able to polish the tool |
| | surfaces |

In all Figures here below there are in some cases only one, two or three measuring values and that is because the samples were brittle and impossible to render a density (neither 1 nor 2). But still the stickiness index could be determined.

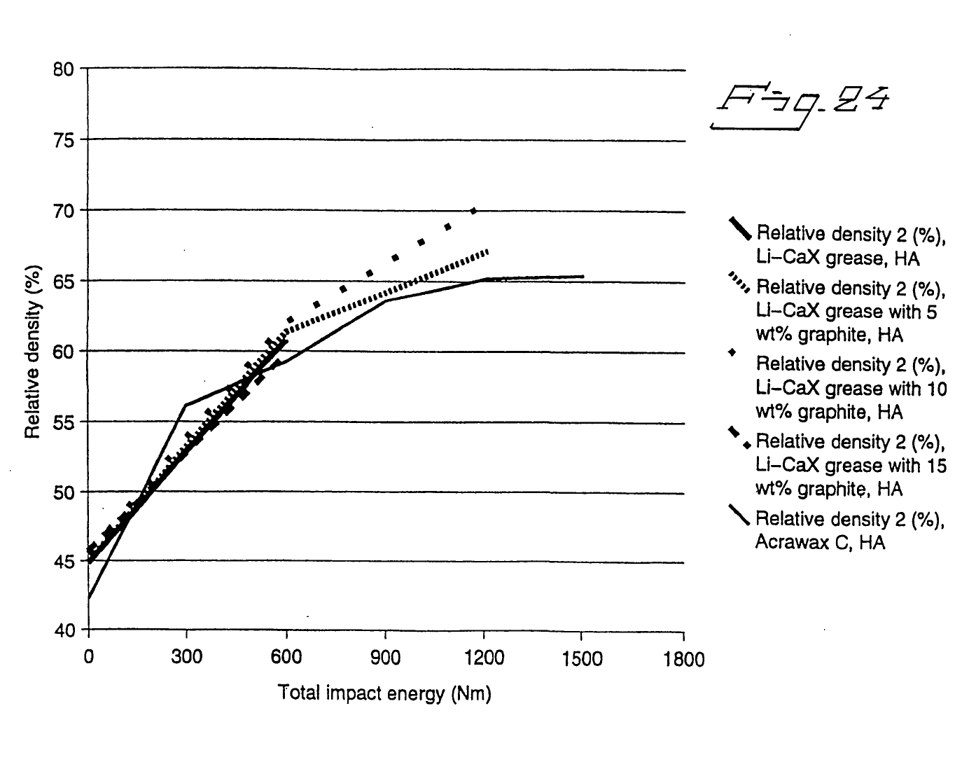

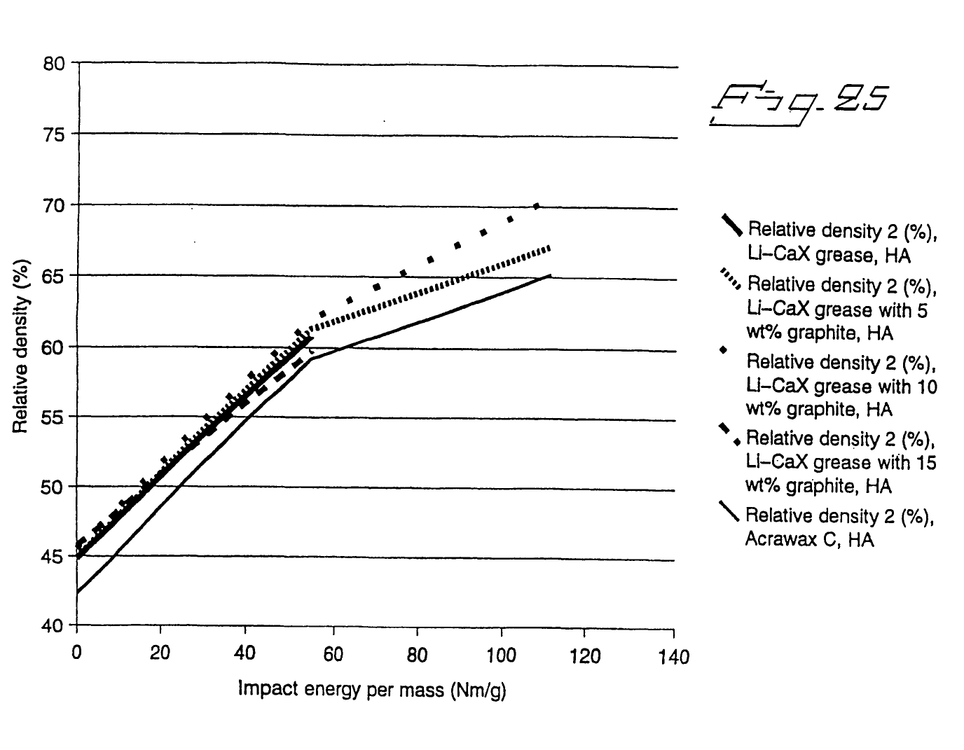

Li—CaX grease with different amounts of graphite added FIGS. 24-25 show relative density as a function of total impact energy and impact energy per mass. The following described phenomena could be seen for all curves.

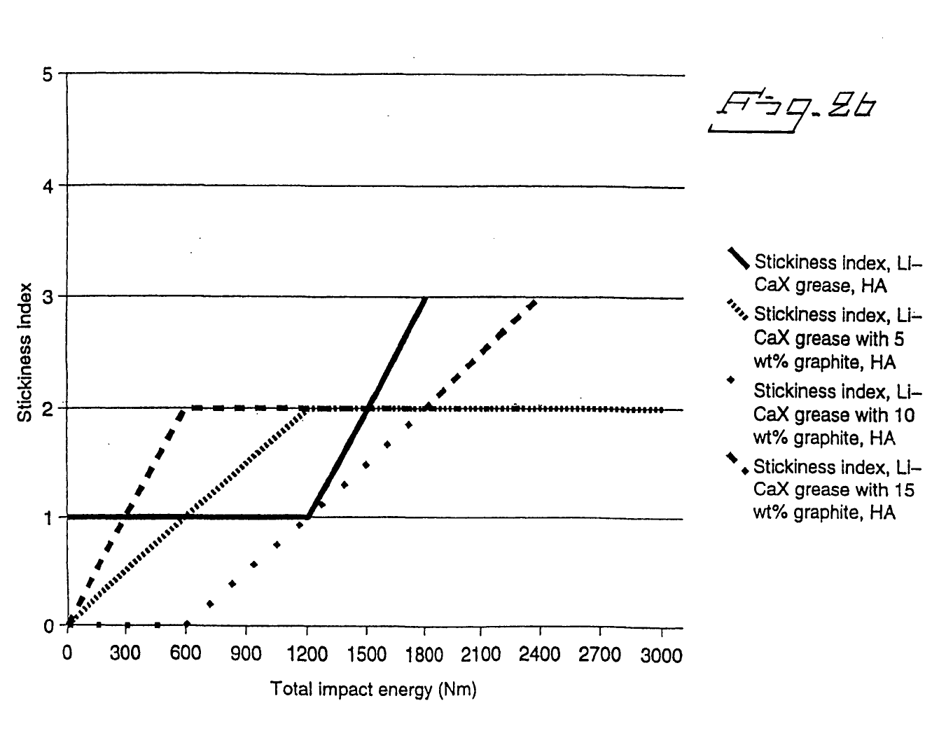

FIG. 26 shows stickiness index as a function of total impact energy for five curves. The curve with Acrawax C as lubricant is a reference curve to the curves where Li—CaX grease with different amounts of graphite has been added.

All samples had visibility index 2.

Samples with Acrawax C obtained the lowest relative density. Instead samples with Li—CaX grease with 10 wt % graphite obtained the highest relative density, 6% higher than with Acrawax C. After Li—CaX grease with 10 wt % graphite follows Li—CaX with 5 wt % graphite and then 15 wt % graphite and pure Li—CaX.

Concerning the stickiness index the samples with Li—CaX grease with 10 wt % graphite obtained the lowest stickiness index. Then follows Li—CaX with 5 wt % graphite, with 15 wt % graphite and pure Li—CaX did stick most to the tool surfaces.

TABLE 10

| | Stickiness index | | | |
|---|---|---|---|---|
| | | | Li—CaX, | Li—CaX, |
| Total impact | | Li—CaX, 5 wt % | 10 wt % | 15 wt % |
| energy (Nm) | Li—CaX | graphite | graphite | graphite |
| 0 | 1 | 0 | 0 | 0 |
| 300 | | | | |
| 600 | 1 | 1 | 0 | 2 |
| 900 | | | | |
| 1200 | 1 | 2 | 1 | 2 |
| 1500 | | | | |
| 1800 | 1 | 2 | 2 | 2 |
| 2100 | | | | |
| 2400 | 3 | 2 | 2 | 3 |
| 2700 | | | | |
| 3000 | | 2 | | |

Oils with Different Viscosities

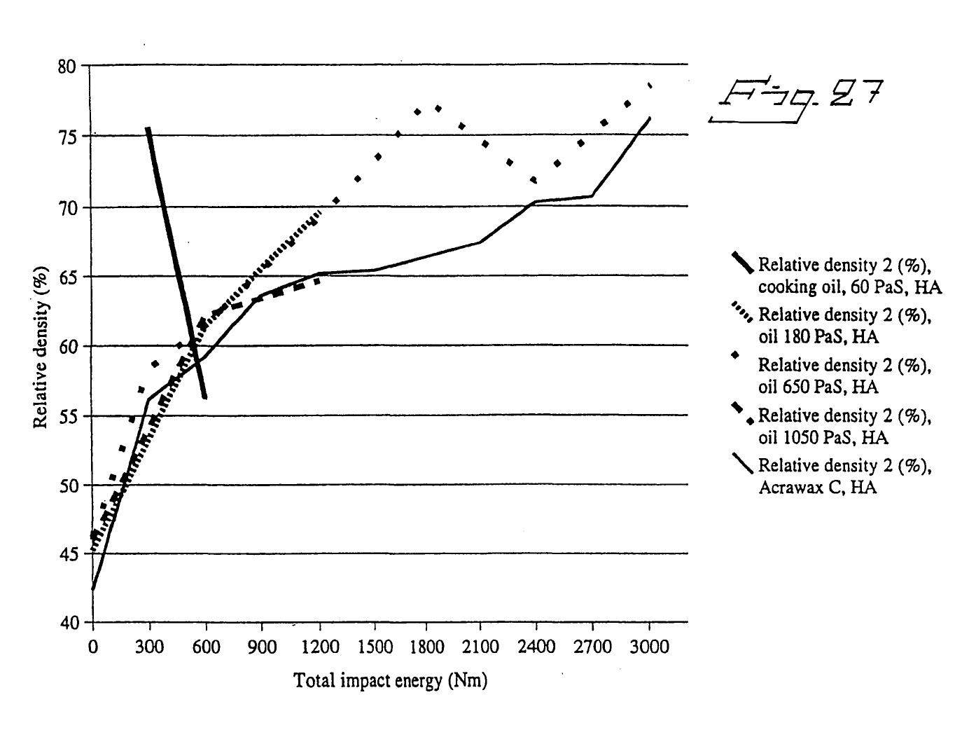

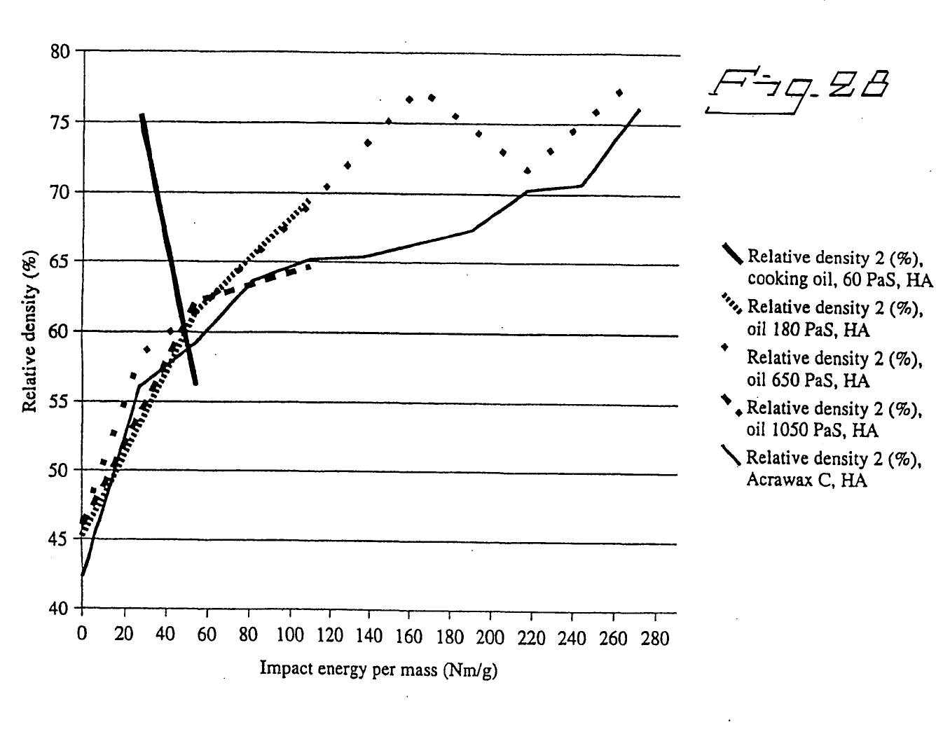

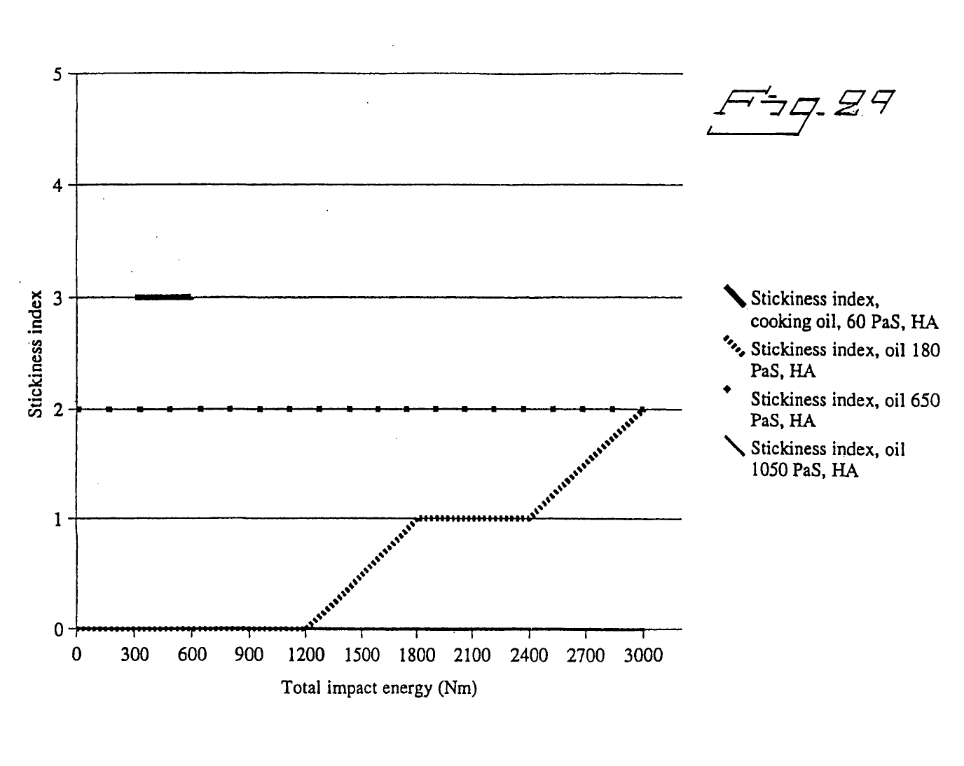

FIGS. 27 and 28 show relative density as a function of total impact energy and impact energy per mass. The following described phenomena could be seen for all curves. FIG. 29 shows stickiness index as a function of total impact energy for five curves. The curve with Acrawax C as lubricant is a reference curve to the curves where oils with different viscosity have been used.

All samples had visibility index 2.

The samples with oil with 650 PaS obtained the highest relative density and 2% higher than Acrawax C. The curve with oil with a viscosity of 180 PaS follows the curve with oil with 650 PaS, but the test was stopped at a low impact energy. Thereafter follow the batch with oil with 1050 PaS and thereafter cooking oil. The density decreased from 75 to 56% of relative density with cooking oil as lubricant.

The oil with 1050 PaS had stickiness index 0 all the way up to 3000 Nm. The oil with 180 PaS had 0 to 1200 Nm and then follow oil with 650 PaS and cooking oil (60 PaS).

See table 11 for results of stickiness indexes for oils with different viscosities.

TABLE 11

| Total impact | Stickiness index | | | |
|---|---|---|---|---|
| energy (Nm) | Cooking oil | Oil, 180 PaS | Oil, 650 PaS | Oil, 1050 PaS |
| 0 | 3 | 0 | 2 | 0 |
| 300 | 3 | | | |
| 600 | | 0 | 2 | 0 |
| 900 | | | | |
| 1200 | | 0 | 2 | 0 |
| 1500 | | | | |
| 1800 | | 1 | 2 | 0 |
| 2100 | | | | |
| 2400 | | 1 | 2 | 0 |
| 2700 | | | | |
| 3000 | | 2 | 2 | 0 |

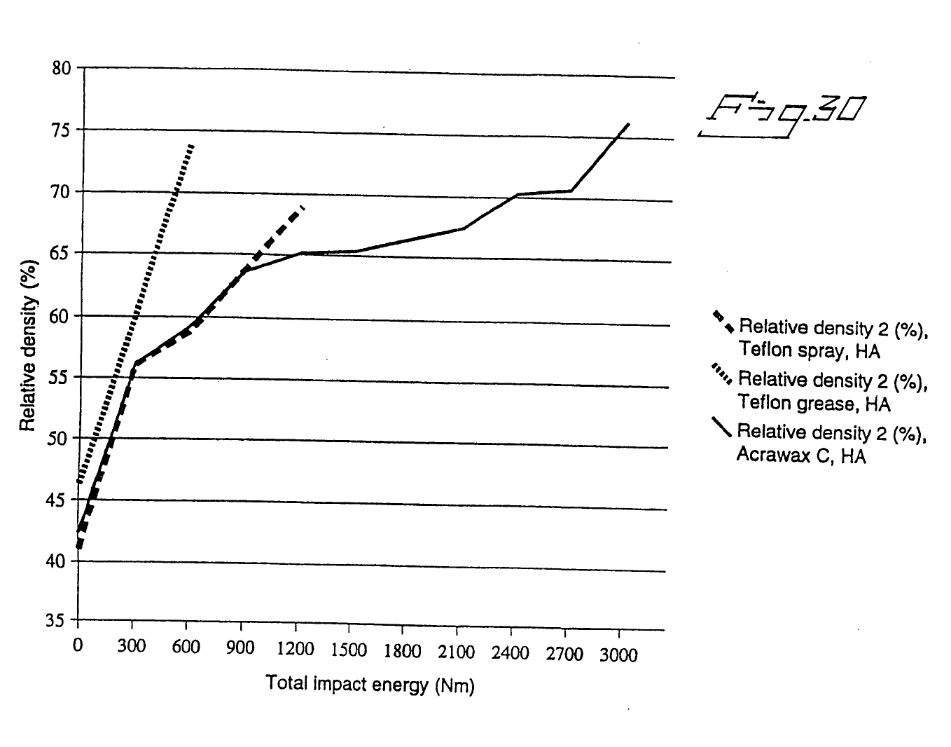

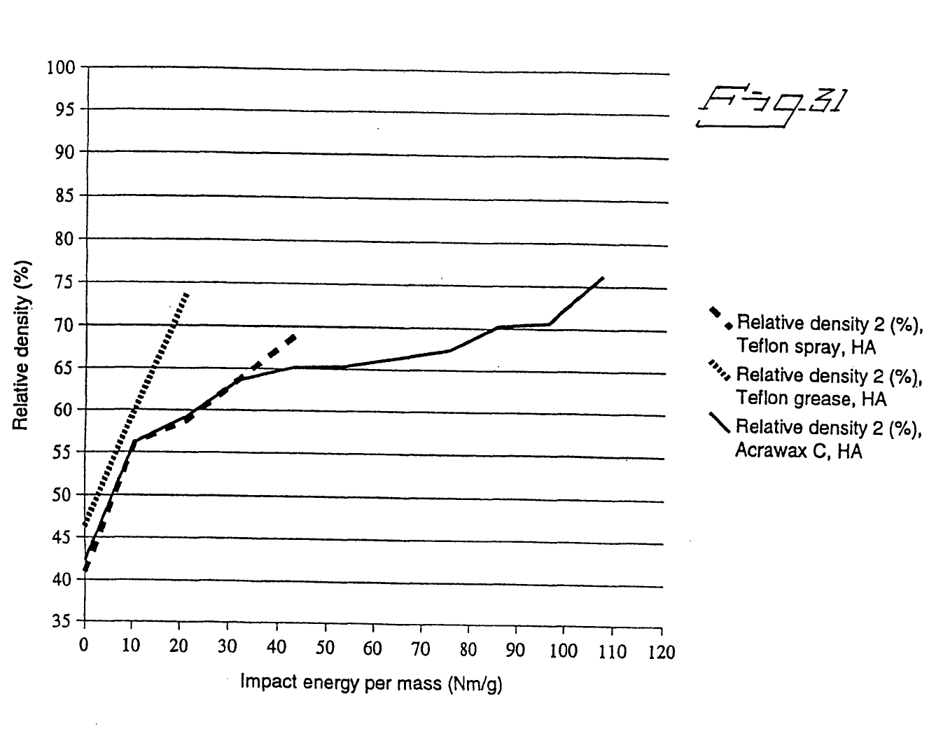

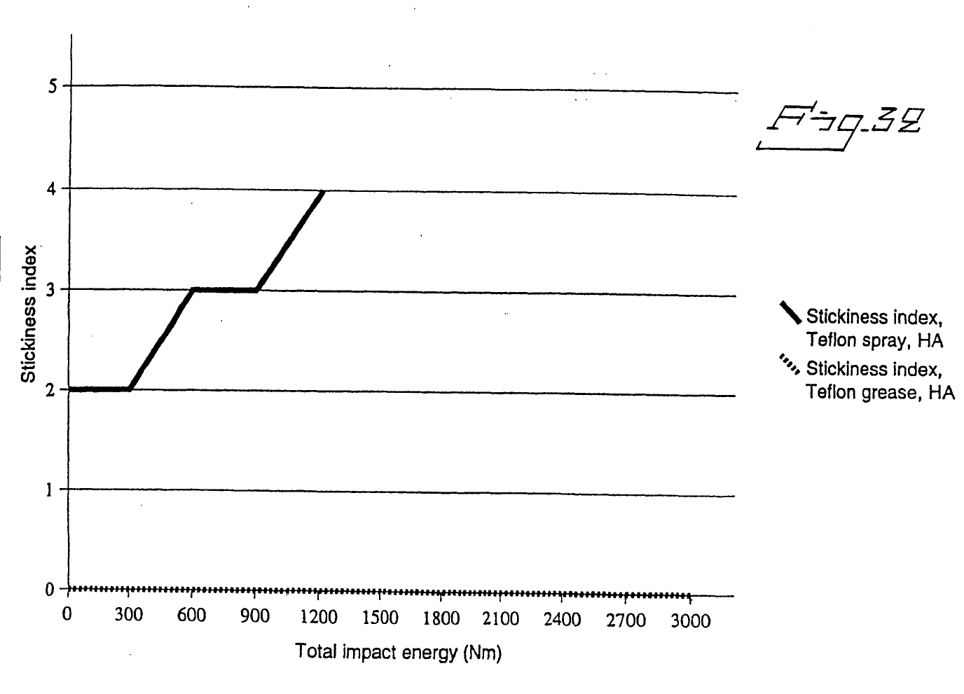

Teflon Spray and Teflon Grease FIGS. 30 and 31 show relative density as a function of total impact energy and impact energy per mass. The following described phenomena could be seen for all curves. FIG. 32 shows stickiness index as a function of total impact energy for two curves.

All samples had visibility index 2.

Teflon grease as lubricant rendered the highest relative density. Already after the pre-compacting the relative density was 4-5% higher than with Acrawax C. With Teflon spray the same relative density as Acrawax C was obtained. But the test was stopped at a low impact energy because the material did stick to the tool surfaces.

With Teflon grease the stickiness index 0 was obtained during the whole test, while the Teflon spray stickiness index started at 2 already after the pre-compacting.

See table 12 for results of stickiness indexes of Teflon oil respectively grease.

TABLE 12

| | |
|---|---|
| Total impact | Stickiness index |

| energy (Nm) | Teflon oil | Teflon grease |
|---|---|---|
| 0 | 2 | 0 |
| 300 | 2 | |
| 600 | 3 | 0 |
| 900 | 3 | |
| 1200 | 4 | 0 |
| 1500 | | |
| 1800 | | |
| 2100 | | 0 |
| 2400 | | |
| 2700 | | 0 |
| 3000 | | |

Grease with White (Synthetic) Graphite Added

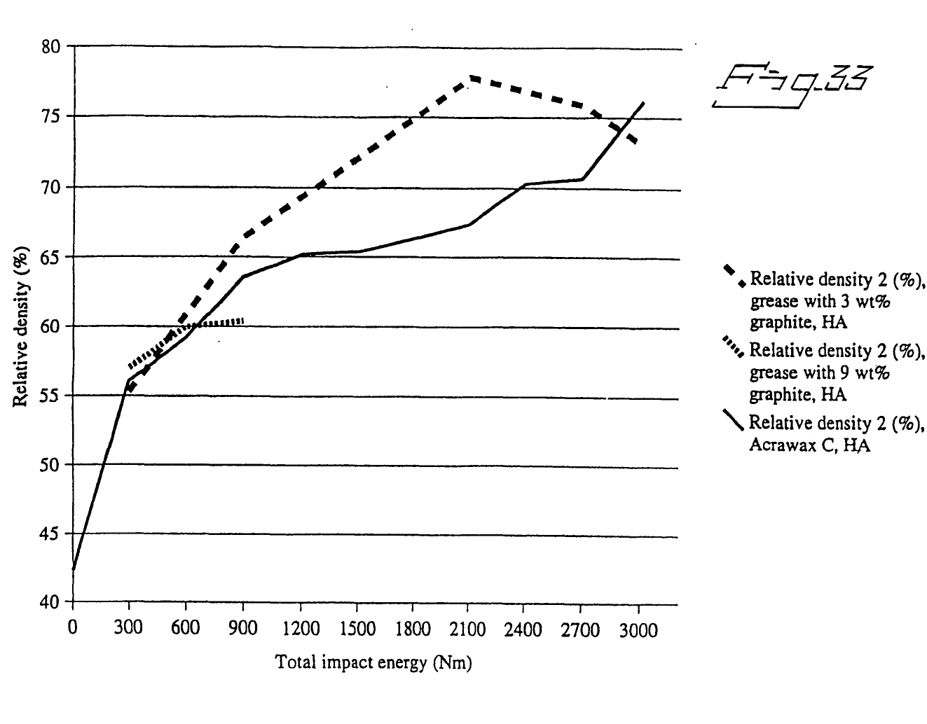

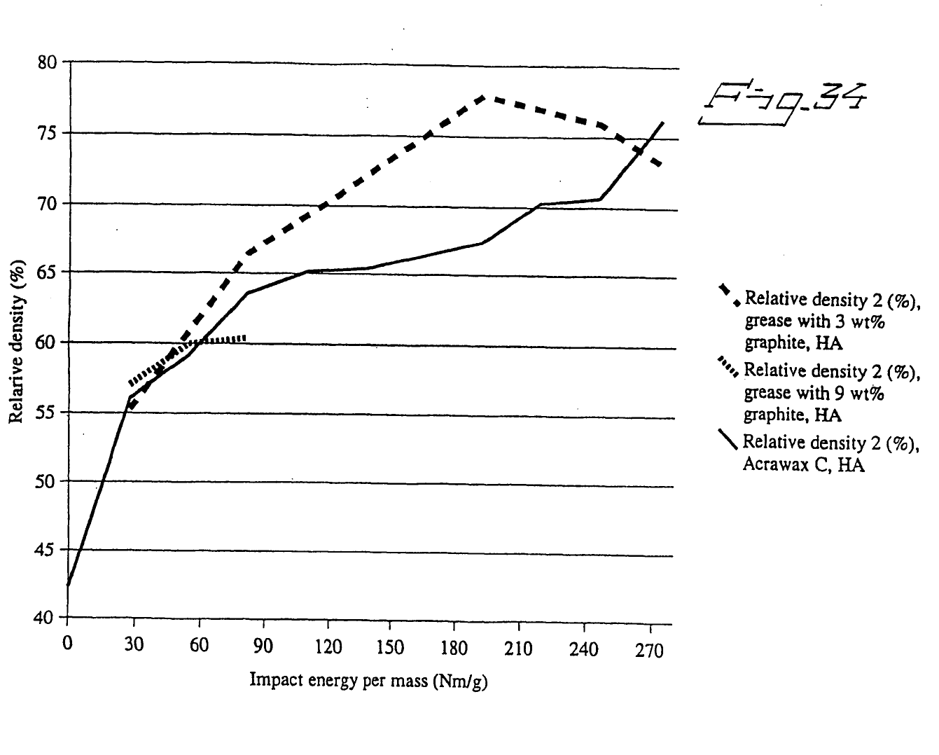

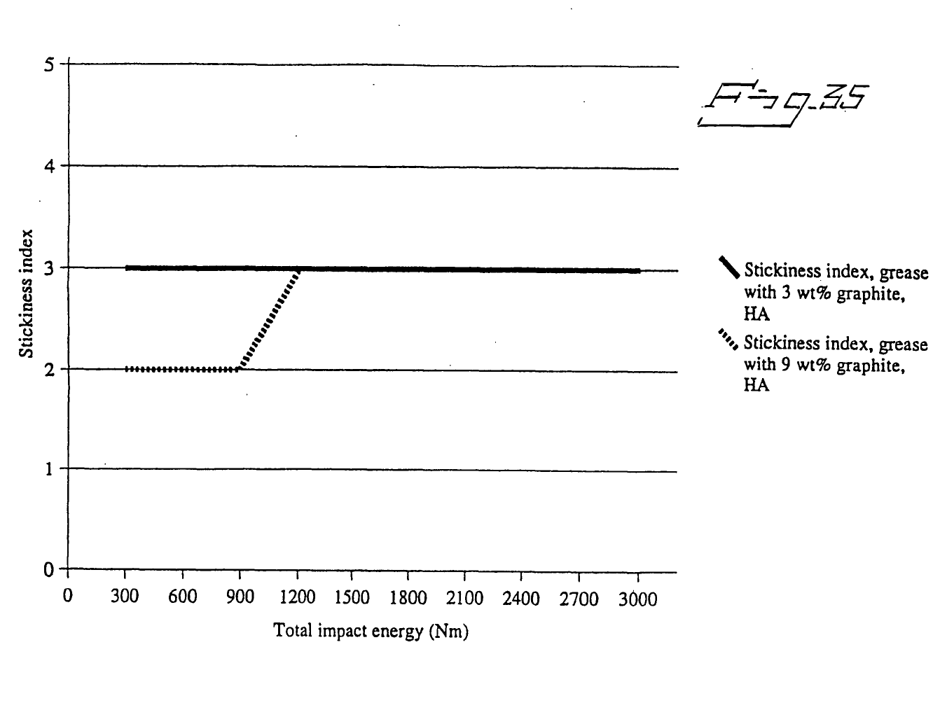

FIGS. 33 and 34 show relative density as a function of total impact energy and impact energy per mass. The following described phenomena could be seen for all curves. FIG. 35 shows stickiness index as a function of total impact energy for two curves.

All samples had visibility index 2.

The batch with grease with 9 wt % graphite added the test was not performed to a high impact energy. Comparing Acrawax C with grease with 3 wt % graphite, the relative density is higher with grease with 3 wt % graphite. With this lubrication a peak of the relative density has been found at 2100 Nm, 78%, which is 10% higher relative density than that obtained for the test with Acrawax C. But owing to the fact that the relative density of the samples with grease with 3 wt % decrease at higher energies, the samples produced with Acrawax C obtain a higher relative density at maximum impact energy, 3000 Nm.

Both lubrication types, grease with 3 and 9 wt % graphite, obtained a stickiness index that was too high already after the pre-compacting.

See table 13 for results of stickiness indexes of oils with different viscosity.

TABLE 13

Stickiness index

| Total impact | 3 wt % | 9 wt % |
|---|---|---|
| energy (Nm) | graphite in grease | graphite in grease |
| 0 | 2 | 0 |
| 300 | 2 | 0 |
| 600 | 3 | 0 |
| 900 | 3 | 0 |
| 1200 | 4 | 0 |
| 1500 | | 0 |
| 1800 | | |
| 2100 | | |
| 2400 | | |
| 2700 | | |
| 3000 | | |

Grease with Talc in Different Combinations

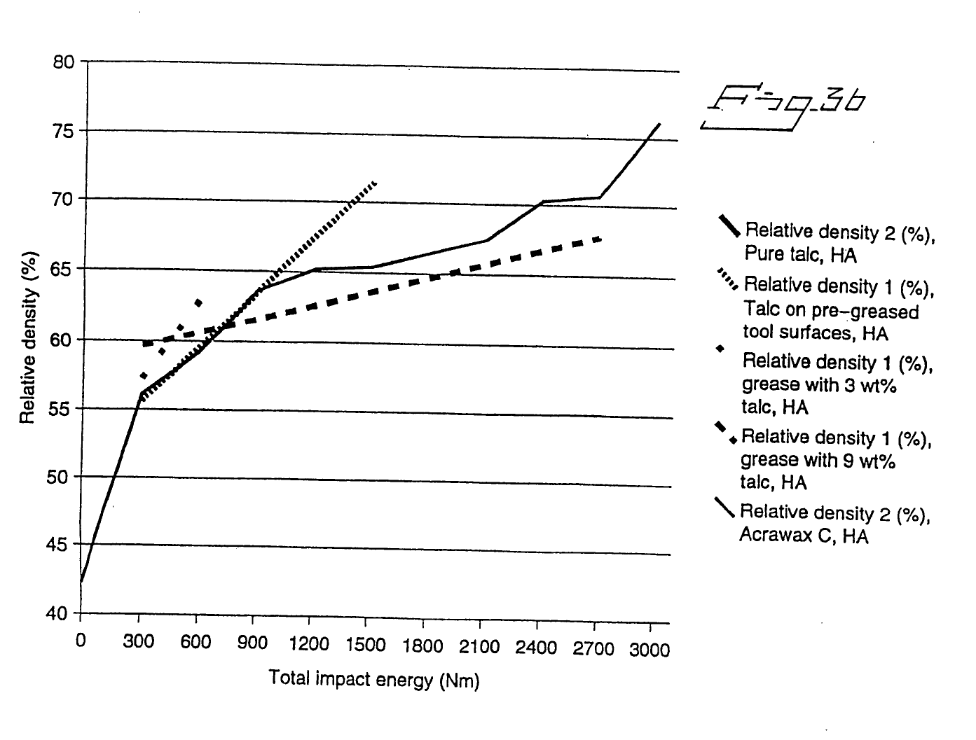

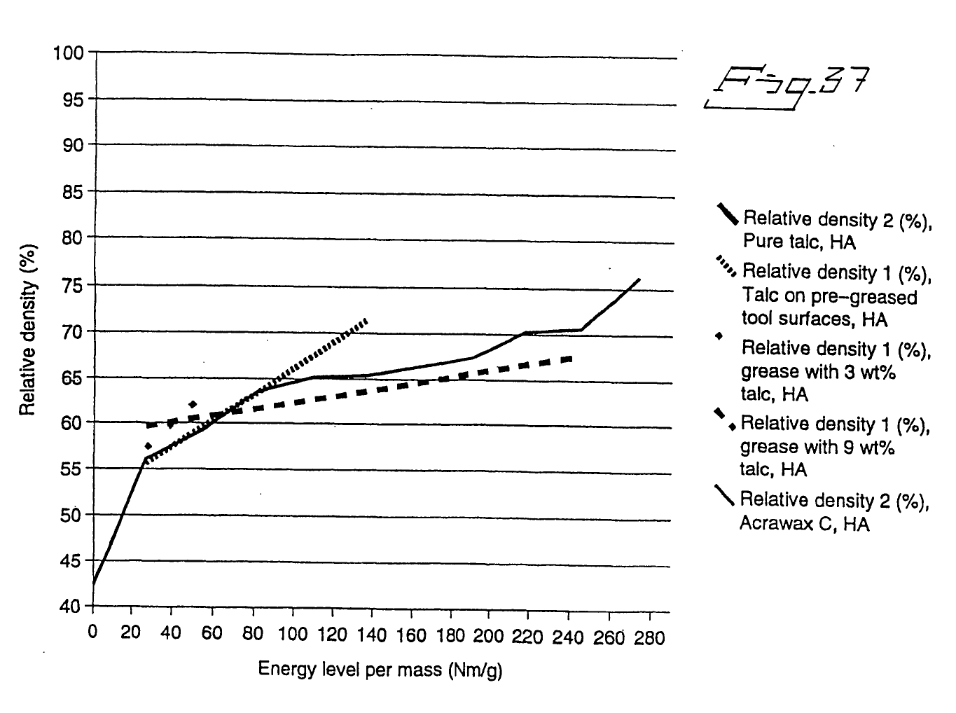

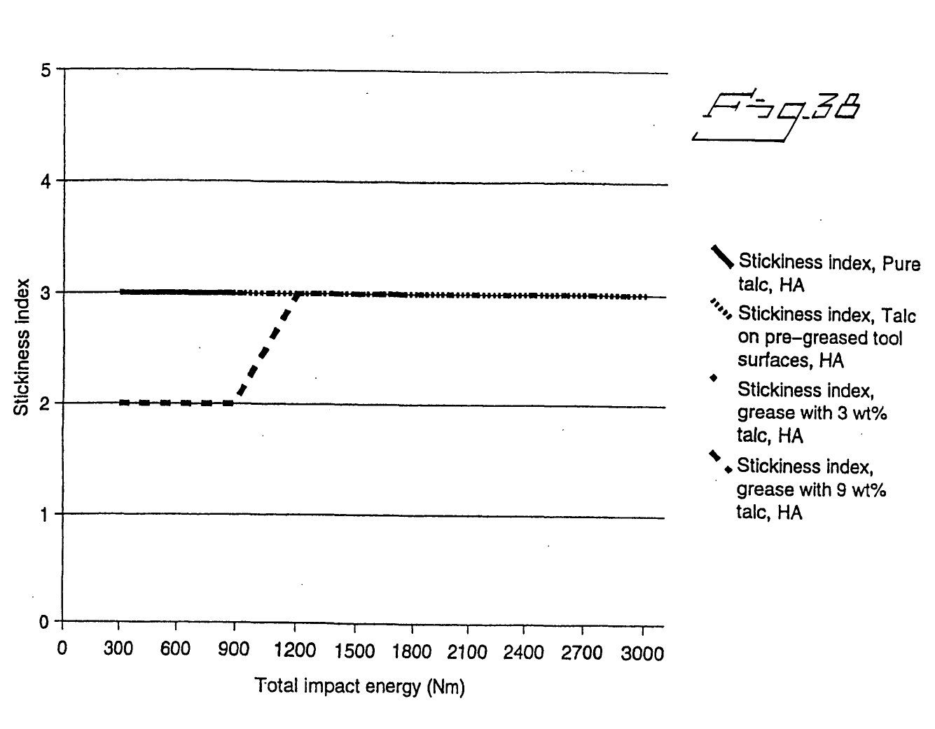

FIGS. 36 and 37 show relative density as a function of total impact energy and impact energy per mass. The following described phenomena could be seen for all curves. FIG. 38 shows stickiness index as a function of total impact energy for four curves.

All samples had visibility index 2.

The obtained relative densities of the batches were different. The samples where pure talc was powdered on the tool surfaces a lower relative density was obtained compared with the other batches. The samples where talc was powdered on a pre-greased tool surface rendered the highest relative density. Thereafter follows Acrawax C and the lowest relative density was obtained with grease with 9 wt % talc.

All types of lubricant types rendered a stickiness index that was too high already after the pre-compacting.

See table 14 for results of stickiness indexes of grease with different amount of talc added.

TABLE 14

| | Stickiness index | | | |
|---|---|---|---|---|
| Total impact | | Talc on pre- | Grease with | Grease with |
| energy (Nm) | Pure talc | greased surfaces | 3 wt % talc | 9 wt % talc |
| 0 | | | | |
| 300 | 3 | 3 | 3 | 2 |
| 600 | 3 | 3 | 3 | 2 |
| 900 | | 3 | 3 | 2 |
| 1200 | | 3 | 3 | 3 |
| 1500 | | 3 | 3 | 3 |
| 1800 | | 3 | | 3 |
| 2100 | | 3 | 3 | |
| 2400 | | 3 | | |
| 2700 | | 3 | 3 | |
| 3000 | | 3 | 3 | |

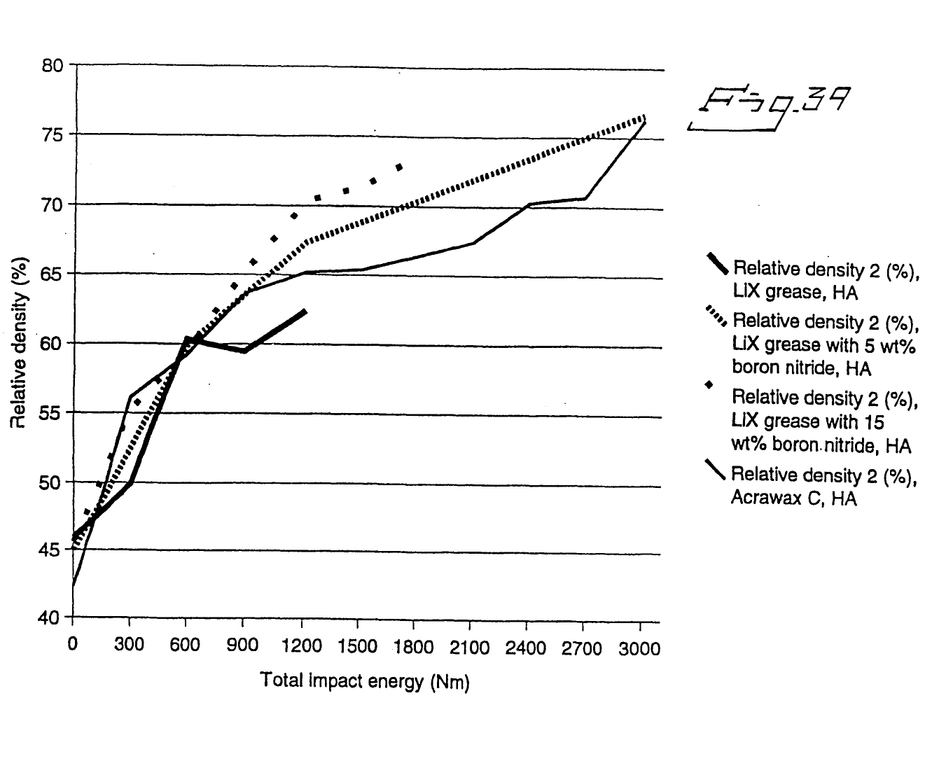

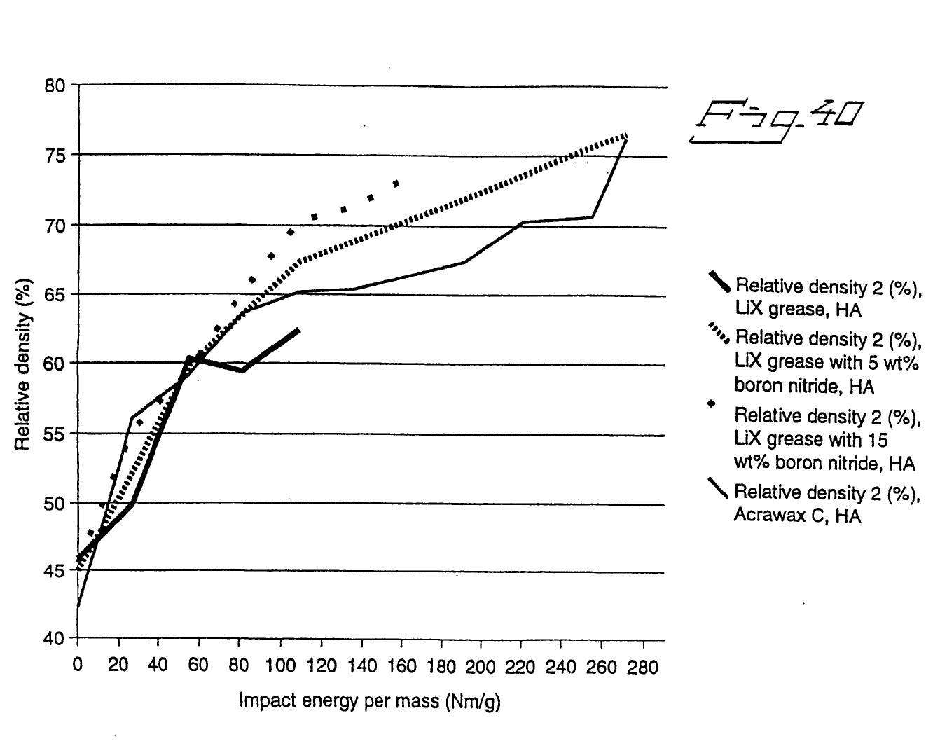

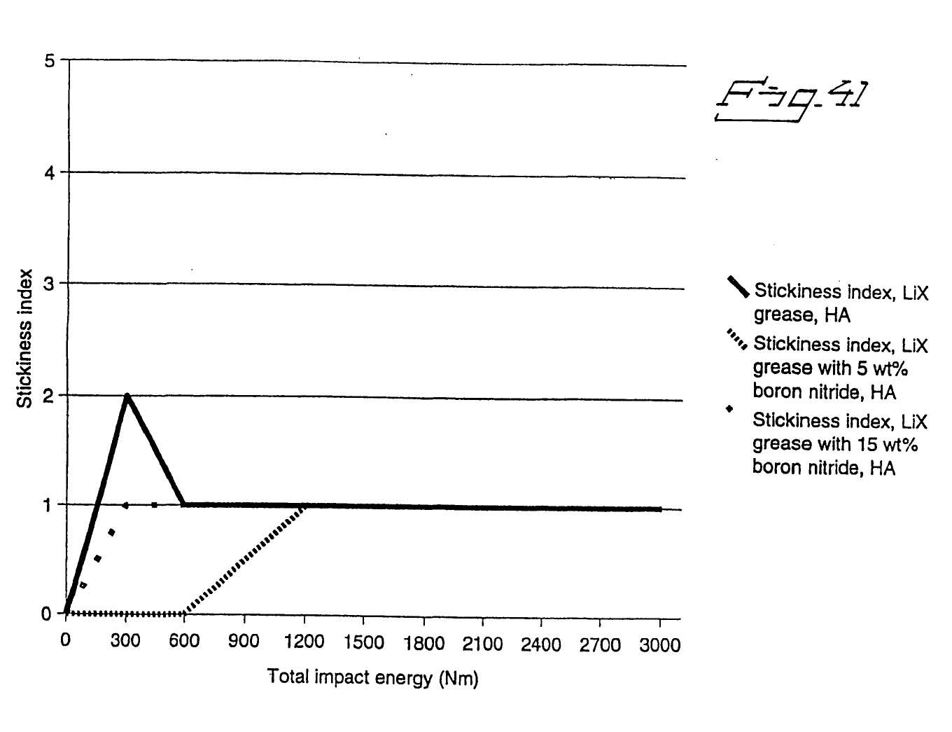

LiX Grease with Different Amount Boron Nitride Added FIGS. 39 and. 40 show relative density as a function of total impact energy and impact energy per mass. The following described phenomena could be seen for all curves. FIG. 41 shows stickiness index as a function of total impact energy for three curves.

All samples had visibility index 2.

The highest relative density was obtained with LiX (lithium stearate) with 15 wt % boron nitride. This test stopped at 1800 Nm and at that impact energy level the density was ˜6% higher than samples with Acrawax C. Thereafter follow samples with Acrawax C, LiX with 5 wt % boron nitride and then pure LiX.

The stickiness index of LiX with 5 wt % had the lowest stickiness index, and thereafter follows LiX with 15 wt %. Pure LiX had the highest stickiness index.

See table 15 for results of stickiness indexes of LiX grease with different amount of boron nitride added.

TABLE 15

| | Stickiness index | | |
|---|---|---|---|
| | | LiX grease with | LiX grease with |
| Total impact | | 5 wt % boron | 15 wt % boron |
| energy (Nm) | LiX grease | nitride | nitride |
| 0 | 0 | 0 | 0 |
| 300 | 2 | | 1 |
| 600 | 1 | 0 | 1 |
| 900 | 1 | | 1 |
| 1200 | 1 | 1 | 1 |
| 1500 | 1 | | 1 |
| 1800 | 1 | 1 | 1 |
| 2100 | 1 | | 1 |
| 2400 | 1 | 1 | 1 |
| 2700 | 1 | | 1 |
| 3000 | 1 | 1 | 1 |

Other Types of Greases and Oils as Lubricants

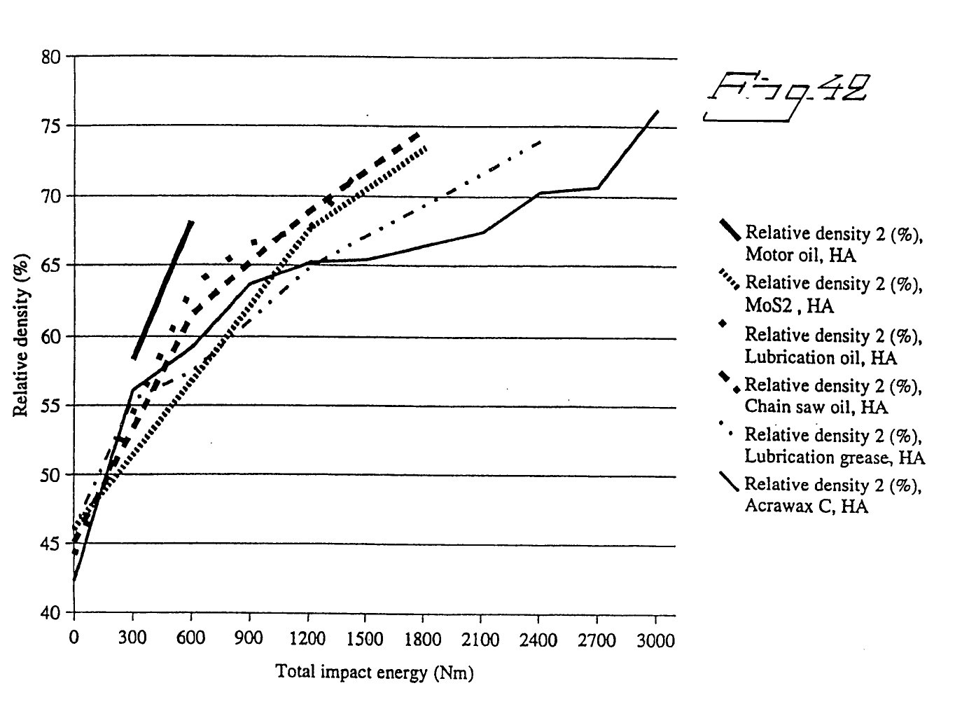

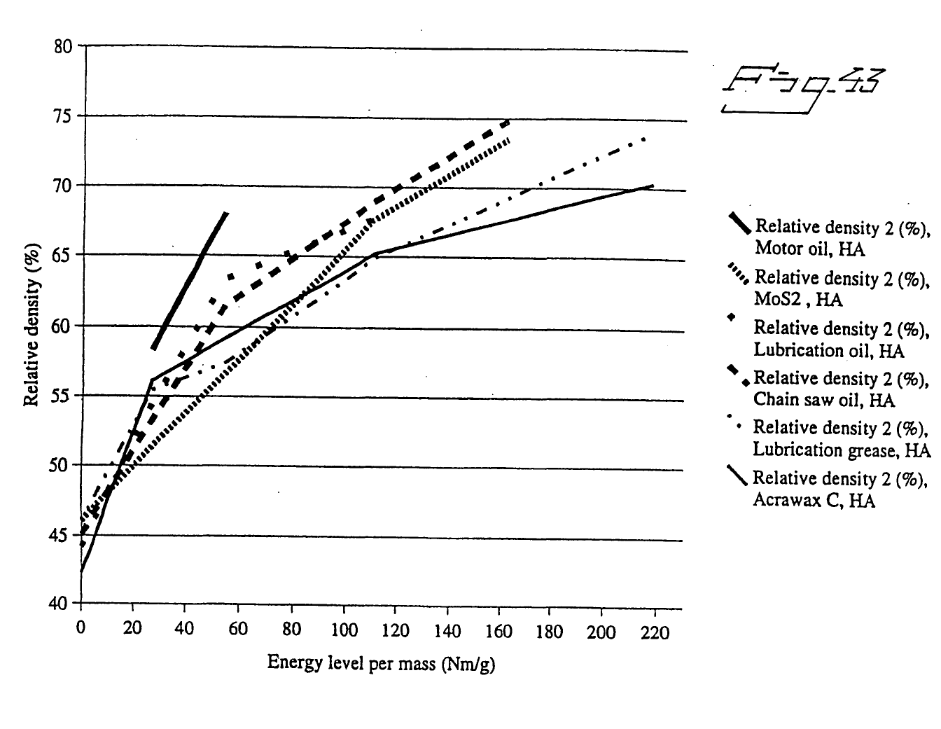

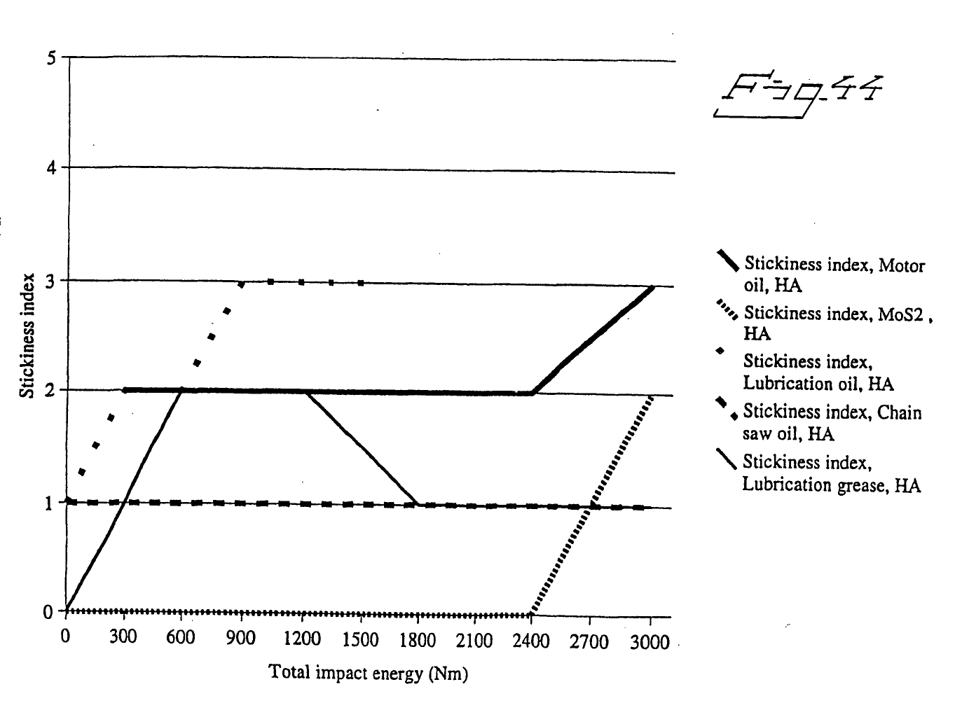

FIGS. 42 and 43 show relative density as a function of total impact energy and impact energy per mass. The following described phenomena could be seen for all curves. FIG. 44 shows stickiness index as a function of total impact energy for five curves.

All samples had visibility index 2.

Samples with motor oil had the highest relative density at low impact energy, but only a few samples were produced. Thereafter follow samples produced with lubrication oil, chain saw oil, Acrawax C, MoS₂ and lubrication grease.

The stickiness index of MoS₂ was 0 during the whole test series. Thereafter follow lubrication grease, chain saw oil, lubrication oil and the highest stickiness index was obtained with motor oil.

See table 16 for results of stickiness indexes of different greases and oils.

TABLE 16

| Total | | | | | |
|---|---|---|---|---|---|
| impact | Stickiness index | | | | |
| energy | Motor | | Lubrication | Chain | Lubrication |
| (Nm) | oil | MoS₂ | oil | saw oil | grease |
| 0 | | 0 | 1 | 1 | 0 |
| 300 | 2 | | 2 | | 1 |
| 600 | 2 | 0 | 2 | 1 | 2 |
| 900 | | | 3 | | |
| 1200 | 2 | 0 | 3 | 1 | 2 |
| 1500 | | | 3 | | |
| 1800 | 2 | 0 | | 1 | 1 |
| 2100 | | | | | |
| 2400 | 2 | 0 | | 1 | 1 |
| 2700 | | | | | |
| 3000 | 3 | 2 | | 1 | 1 |

With some of the lubricants there was only a need of wiping with a dry rag. But depending on what external lubricant that was used different amounts of material lefts did stick to the tool. Otherwise the moulding die and the impact stamp stayed in good shape.

The external lubricants were applied with a paint brush on the lower stamp (side that is in contact with the powder and at the sides that are in contact with the moulding die), the moulding die and at the impact stamp (both on the side that is in contact with the powder and on the sides that are in contact with the moulding die). All to be enable an easier release of the stamps and the sample and avoid powder rests on the tool.

One interesting alternative to make the process even smoother a possibility is to coat the moulding die and the impact stamp with e.g. TiNAl or Balinit Hardlube. That would decrease the friction between the powder and the tool surfaces and hopefully would no material get stuck on the tool walls. That means that perhaps could the external lubricant be excluded which would reduce the cycle time of the sample production. The coating would also make it possible to avoid the polishing after each sample. If there is no need of polishing of the tool, this manufacturing process could be automatic, which is difficult today. If external lubricant would be required as well the combination of coating and external lubricant could render a clean surface. One of all material types have been tested with and without coating and with the coating the result was better even though there was no external lubricant used. No material got stuck on the tool surfaces at all.

The tests show that the external lubricant affects both the relative density and the thickness to the tool surfaces. Some lubricants possibly decrease the friction between the tool surfaces and the powder. In these cases a higher relative density could possibly be obtained compared with lubricants with a high friction. With low friction the stroke unit is able to perform its stroke with the installed impact energy and higher density could be obtained.

To find a lubricant that enable clean tool surfaces there are some parameters that need to be tested out. The bearing capacity of the lubricant is probably important. If the powder can get through the lubricant the powder can possibly stick to the tool wall. If a lubricant with a high viscosity, which probably means high bearing capacity, the powder could possibly be avoided to stick to the tool wall.

With oil with viscosity of 1050 PaS the stickiness index was 0 through the whole test series. Probably that high viscosity was required to keep the distance between the powder and the tool surface. Teflon grease also rendered stickiness index 0 through the whole test series. In this case it seemed to be a better bearing surface with Teflon in grease compared with in oil. It is a question today what the optimal composition is. Does Teflon increase the bearing surface, and its properties get fully developed together with grease compared with oil?

New lubricants should be tested as well. A mix of Kenolube and lithium stearate (our LiX in these tests) may give the best results. There could be other combinations of lubricants where the properties from both lubricants are present.

The invention concerns a new method which comprises both pre-compacting and in some cases post-compacting and there between at least one stroke on the material. The new method has proved to give very good results and is an improved process over the prior art.

The invention is not limited to the above described embodiments and examples. It is an advantage that the present process does not require the use of additives. However, it is possible that the use of additives could prove advantageous in some embodiments. Likewise, it is usually not necessary to use vacuum or an inert gas to prevent oxidation of the material body being compressed. However, some materials may require vacuum or an inert gas to produce a body of extreme purity or high density. Thus, although the use of additives, vacuum and inert gas are not required according to the invention the use thereof is not excluded. Other modifications of the method and product of the invention may also be possible within the scope of the following claims.

1. A method of producing a ceramic body by coalescence, characterised in that the method comprises the steps of
a) filling a pre-compacting mould with ceramic material in the form of powder, pellets, grains and the like,
b) pre-compacting the material at least once and
c) compressing the material in a compression mould by at least one stroke, where a striking unit emits enough kinetic energy to form the body when striking the material inserted in the compression mould, causing coalescence of the material.

2. A method according to claim 1, characterised in that the pre-compacting mould and the compressing mould are the same mould.

3. A method according to any of the preceding claims for producing a body of hydroxyapatite, characterised in that the material is pre-compacted with a pressure of at least about 0.25×10⁸ N/m², in air and at room temperature.

4. A method according to claim 3, characterised in that the material is pre-compacted with a pressure of at least about 0.6×10⁸ N/m².

5. A method according to any of the preceding claims, characterised in that the method comprises pre-compacting the material at least twice.

6. A method of producing a ceramic body by coalescence, characterised in that the method comprises compressing material in the form of a solid ceramic body in a compression mould by at least one stroke, where a striking unit emits enough energy to cause coalescence of the material in the body.

7. A method according to any of claims 1-5 or claim 6, characterised in that the compression strokes emit a total energy corresponding to at least 100 Nm in a cylindrical tool having a striking area of 7 cm² in air and at room temperature.

8. A method according to claim 7, characterised in that the compression strokes emit a total energy corresponding to at least 300 Nm in a cylindrical tool having a striking area of 7 cm².

9. A method according to claim 8, characterised in that the compression strokes emit a total energy corresponding to at least 600 Nm in a cylindrical tool having a striking area of 7 cm².

10. A method according to claim 9, characterised in that the compression strokes emit a total energy corresponding to at least 1000 Nm in a cylindrical tool having a striking area of 7 cm².

11. A method according to claim 10, characterised in that the compression strokes emit a total energy corresponding to at least 2000 Nm in a cylindrical tool having a striking area of 7 cm².

12. A method according to any of claim 1-5 or claim 6, characterised in that the compression strokes emit an energy per mass corresponding to at least 5 Nm/g in a cylindrical tool having a striking area of 7 cm² in air and at room temperature.

13. A method according to claim 12, characterised in that the compression strokes emit an energy per mass corresponding to at least 20 Nm/g in a cylindrical tool having a striking area of 7 cm².

14. A method according to claim 13, characterised in that the compression strokes emit an energy per mass corresponding to at least 100 Nm/g in a cylindrical tool having a striking area of 7 cm².

15. A method according to claim 14, characterised in that the compression strokes emit an energy per mass corresponding to at least 250 Nm/g in a cylindrical tool having a striking area of 7 cm².

16. A method according to claim 15, characterised in that the compression strokes emit an energy per mass corresponding to at least 350 Nm/g in a cylindrical tool having a striking area of 7 cm².

17. A method according to any of the preceding claims, characterised in that the ceramic is compressed to a relative density of at least 45%, preferably 50%.

18. A method according to claim 17, characterised in that the ceramic is compressed to a relative density of at least 55%, preferably 60%.

19. A method according to claim 18, characterised in that the ceramic is compressed to a relative density of at least 70%, preferably at least 80% and especially at least 90% up to 100%.

20. A method according to any of the preceding claims, characterised in that the method comprises a step of post-compacting the material at least once after the compression step.

21. A method according to any of the preceding claims, characterised in that the ceramic is chosen from the group comprising minerals, oxides, carbides, nitrides.

22. A method according to claim 21, characterised in that the ceramic is chosen from the group comprising alumina, silica, silicon nitride, zirconia, silicon carbide and hydroxyapatite.

23. A method according to any of the preceding claims, characterised in that the body produced is a medical implant, such as a skeletal or tooth prosthesis.

24. A method according to any of the preceding claims, characterised in that the method comprises a step of post-heating and/or sintering the body any time after the compression or the post-compacting.

25. A method according to any of the preceding claims, characterised in that the body produced is a green body.

26. A method of producing a body according to claim 27, characterised in that the method also comprises a further step of sintering the green body.

27. A method according to any of the preceding claims, characterised in that the material is a medically acceptable material.

28. A method according to any of the preceding claims, characterised in that the material comprises a lubricant and/or a sintering aid.

29. A method according to claim 6, characterised in that the method also comprises deforming the body.

30. A product obtained by the method according to any of claims 1-30.

31. A product according to claim 31, characterised in being a medical device or instrument.

32. A product according to claim 31, characterised in being a non medical device.
